(19) United States
(12) Patent Application Publication
(10) Pub. No.: US 2013/0132109 A1
(43) Pub. Date: May 23, 2013

(54) SYSTEM AND METHOD FOR REMOTE MANAGEMENT OF MEDICAL DEVICES AND PATIENTS

(71) Applicants: Subrahmanya R. Mruthyunjaya, Bangalore (IN); Sivaram Lakshminarasimhan, Velachery (IN); Rashmi Shenoy, Chikkalasandra (IN)

(72) Inventors: Subrahmanya R. Mruthyunjaya, Bangalore (IN); Sivaram Lakshminarasimhan, Velachery (IN); Rashmi Shenoy, Chikkalasandra (IN)

(73) Assignee: INFOSYS LIMITED, Bangalore (IN)

(21) Appl. No.: 13/350,990

(22) Filed: Jan. 16, 2012

(30) Foreign Application Priority Data
Nov. 17, 2011 (IN) 3944/CHE/2011

(51) Int. Cl. G06Q 50/22

(52) U.S. Cl. 705/2

(57) ABSTRACT

A system for remote management of patients and medical devices is provided. The system comprises one or more medical devices configured to measure one or more patient's health parameters. Further, the system comprises a personal health gateway configured to receive the one or more measured patient's health parameters. The personal health gateway further comprises a management module. Furthermore, the system comprises a public network configured to connect the one or more personal health gateways to a managed patient services platform. The managed patient services platform is configured to facilitate remote management of the one or more medical devices and patients. The managed patient services platform further comprises a management module. The system comprises a hospital system configured to facilitate one or more functionality of a healthcare facility. The management module facilitates medical device management and remote health management by embedding a healthcare protocol with a device management protocol.

### FIELD OF THE INVENTION

The present invention relates generally to a remote healthcare management system. More particularly, the present invention provides a system and method for remote management of medical devices and patients.

### BACKGROUND OF THE INVENTION

In the Healthcare and associated industries, medical devices are being increasingly used for diagnosis, therapy, surgery, and prevention and/or treatment of various diseases. A healthcare provider typically procures devices and equipment from multiple vendors and device manufacturers. These medical devices are managed and serviced as per proprietary technologies and service models existing with a particular vendor or device manufacturer. It is often cumbersome for a single organization to manage and service heterogeneity of medical devices procured from different vendors and device manufacturers. Further, healthcare services cannot be efficiently offered to patients due to lack of common standards for management of these medical devices. Furthermore, medical device parameters cannot be configured dynamically, in real time during the course of a therapy, to provide personalized services to patients as per patients' requirements.

To overcome the above mentioned disadvantages, various standards exist to operate and interoperate various medical devices between vendors' equipment. These healthcare standards mainly concentrate on transmission of health parameters/data related to the patient. For example, several healthcare standards exist such as Health Layer 7 (HL7), ISO-11073, etc. However, a standards-based technology for managing medical devices and patients does not exist that would facilitate medical device management and remote health management. For example, standards and protocols for remotely updating software and/or firmware, installing new applications, detecting faults, configuring medical devices, device diagnostics (remote locking/reset, device shutdown, device backup, device auditing/logging etc.) altering flow of medical data collection, posting questions to patients, etc. does not exist.

In light of the above, there is a need for providing an end to end holistic model to the healthcare industry in the domain of remote medical device and health management. In addition, there is a need for a system and method for remotely managing heterogeneity of medical devices running on different protocols and standards. Further, there is a need to provide a system and method for remote management of patients where healthcare professionals can modify workflow including, but not limited to, vitals collection sequence, hospital in-patient related processes, personalized questions and various important alerts to patients.

### SUMMARY OF THE INVENTION

A system for remote management of patients and medical devices is provided. In various embodiments of the present invention, the system comprises one or more medical devices configured to measure one or more patient's health parameters. Further, the system comprises a personal health gateway configured to receive the one or more measured patient's health parameters. The personal health gateway further comprises a management module. Furthermore, the system comprises a public network configured to connect the one or more personal health gateways to a Managed Patient Services (MPS) platform. The MPS platform is configured to facilitate remote management of the one or more medical devices and patients. The MPS platform further comprises a management module. The system further comprises a hospital system configured to facilitate one or more functionality of a healthcare facility. The management module facilitates medical device management and remote health management by embedding a healthcare protocol with a device management protocol.

In an embodiment of the present invention, the one or more medical devices comprise a management client configured to facilitate medical device management and remote health management by embedding a healthcare protocol with a device management protocol. In another embodiment of the present invention, the management client further comprises a tree management module configured to manage one or more management trees, and is further configured to facilitate medical device management and remote health management. In another embodiment of the present invention, the system further comprises a home network configured to connect the one or more medical devices with the personal health gateway. The one or more medical devices and the personal health gateway reside at patient premise. In yet another embodiment of the present invention, the personal health gateway comprises a disease models repository configured to store data pertaining to one or more disease models. In an embodiment of the present invention, the MPS platform comprises a healthcare provider portal configured to provide one or more options to one or more healthcare providers to perform one or more tasks pertaining to medical device management and remote health management. In another embodiment of the present invention, the MPS platform comprises a service provider portal configured to provide one or more options to one or more service providers to perform one or more tasks pertaining to medical device management and remote health management. In yet another embodiment of the present invention, the MPS platform comprises a patient portal configured to provide one or more options to one or more patients to perform one or more tasks pertaining to medical device management and remote health management. In yet another embodiment of the present invention, the MPS platform comprises a disease models repository configured to store data pertaining to disease models.

A system for remote management of patients and medical devices is provided. In various embodiments of the present invention, the system comprises one or more medical devices configured to measure one or more patient's health parameters. Further, the system comprises an aggregator configured to aggregate the one or more measured patient's health parameters. The aggregator further comprises a management module. Furthermore, the system comprises a public network configured to connect the one or more aggregators to a Managed Patient Services (MPS) platform. The MPS platform is configured to facilitate remote management of the one or more medical devices and patients. The MPS platform further comprises a management module. Also, the system comprises a hospital system configured to facilitate one or more functionality of a healthcare facility. The management module facilitates medical device management and remote health management by embedding a healthcare protocol with a device management protocol.

In an embodiment of the present invention, the one or more medical devices comprise a management client configured to facilitate medical device management and remote health management by embedding a healthcare protocol with a device management protocol. In another embodiment of the present invention, the management client further comprises a tree management module configured to manage one or more management trees, and is further configured to facilitate medical device management and remote health management. In another embodiment of the present invention, the system further comprises a home network configured to connect the one or more medical devices with the aggregator. The one or more medical devices and the aggregator reside at patient premise. In an embodiment of the present invention, the MPS platform comprises a healthcare provider portal configured to provide one or more options to one or more healthcare providers to perform one or more tasks pertaining to medical device management and remote health management. In another embodiment of the present invention, the MPS platform comprises a service provider portal configured to provide one or more options to one or more service providers to perform one or more tasks pertaining to medical device management and remote health management. In yet another embodiment of the present invention, the MPS platform comprises a patient portal configured to provide one or more options to one or more patients to perform one or more tasks pertaining to medical device management and remote health management. In yet another embodiment of the present invention, the MPS platform comprises a disease models repository, configured to store data pertaining to disease models.

A system for remote management of patients and medical devices is provided. In various embodiments of the present invention, the system comprises one or more medical devices configured to measure one or more patient's health parameters. Further, the system comprises an aggregator configured to aggregate the one or more measured patient's health parameters. The aggregator further comprises a management module. Furthermore, the system comprises a hospital network configured to connect the one or more aggregators to a Managed Patient Services (MPS) platform. The MPS platform is configured to facilitate remote management of the one or more medical devices and patients. The MPS platform further comprises a management module. The system further comprises a hospital system configured to facilitate one or more functionality of a healthcare facility. The management module facilitates medical device management and remote health management by embedding a healthcare protocol with a device management protocol.

In an embodiment of the present invention, the one or more medical devices comprise a management client configured to facilitate medical device management and remote health management by embedding a healthcare protocol with a device management protocol. In another embodiment of the present invention, the management client further comprises a tree management module configured to manage one or more management trees, and is further configured to facilitate medical device management and remote health management. In another embodiment of the present invention, the system further comprises a device network configured to connect the one or more medical devices with the aggregator. The one or more medical devices and the one or more aggregators reside at healthcare facility. In an embodiment of the present invention, the MPS platform comprises a healthcare provider portal configured to provide one or more options to one or more healthcare providers to perform one or more tasks pertaining to medical device management and remote health management. In another embodiment of the present invention, the MPS platform comprises a service provider portal configured to provide one or more options to one or more service providers to perform one or more tasks pertaining to medical device management and remote health management. In yet another embodiment of the present invention, the MPS platform comprises a patient portal configured to provide one or more options to one or more patients to perform one or more tasks pertaining to medical device management and remote health management. In yet another embodiment of the present invention, the MPS platform comprises a disease models repository configured to store data pertaining to disease models.

A system for remote management of patients and medical devices is provided. In various embodiments of the present invention, the system comprises one or more medical devices configured to measure one or more patient's health parameters. Further, the system comprises a Managed Patient Services (MPS) platform configured to facilitate remote management of the one or more medical devices and patients. The MPS platform further comprises a management module. Furthermore, the system comprises a hospital system configured to facilitate one or more functionality of a healthcare facility. The management module facilitates medical device management and remote health management by embedding a healthcare protocol with a device management protocol.

In an embodiment of the present invention, the one or more medical devices comprise a management client configured to facilitate medical device management and remote health management by embedding a healthcare protocol with a device management protocol. In another embodiment of the present invention, the management client comprises a tree management module configured to manage one or more management trees and is further configured to facilitate medical device management and remote health management. In another embodiment of the present invention, the system further comprises a public network configured to connect the one or more medical devices to the MPS platform. The one or more medical devices reside at patient premise. In yet another embodiment of the present invention, the system further comprises a hospital network configured to connect the one or more medical devices to the MPS platform. The one or more medical devices reside at the healthcare facility. In an embodiment of the present invention, the MPS platform comprises a healthcare provider portal configured to provide one or more options to one or more healthcare providers to perform one or more tasks pertaining to medical device management and remote health management. In another embodiment of the present invention, the MPS platform comprises a service provider portal configured to provide one or more options to one or more service providers to perform one or more tasks pertaining to medical device management and remote health management. In yet another embodiment of the present invention, the MPS platform comprises a patient portal configured to provide one or more options to one or more patients to perform one or more tasks pertaining to medical device management and remote health management. In yet another embodiment of the present invention, the MPS platform comprises a disease models repository configured to store data pertaining to disease models.

A method for remote management of patients and medical devices is provided. In various embodiments of the present invention, the method comprises the step of measuring one or more patient's health parameters by one or more medical devices. The method further comprises the step of transmitting the measured one or more patient's health parameters and medical device data to a personal health gateway. Further, the method comprises the step of converting the measured one or more patients' health parameters into a predetermined healthcare protocol format to obtain healthcare data. The method further comprises the step of embedding the medical device data and the healthcare data within a device management protocol to create an information model. Furthermore, the method comprises the step of transmitting the information model to a Managed Patient Services (MPS) platform using the device management protocol. The method further comprises extracting the healthcare data and the medical device data embedded within the device management protocol.

A method for remote management of patients and medical devices is provided. In various embodiments of the present invention, the method comprises the step of measuring one or more patient's health parameters by one or more medical devices. Further, the method comprises the step of transmitting the measured one or more patient's health parameters and medical device data to an aggregator. Further, the method comprises the step of converting the measured one or more patient's health parameters into a predetermined healthcare protocol format to obtain healthcare data. The method further comprises embedding the medical device data and the healthcare data within a device management protocol to create an information model. Furthermore, the method comprises the step o transmitting the information model to a Managed Patient Services (MPS) platform using the device management protocol. The method further comprises the step of extracting the healthcare data and the medical device data embedded within the device management protocol.

A method for remote management of patients and medical devices is provided. In various embodiments of the present invention, the method comprises the step of selecting an option from one or more options provided by a user interface. The method further comprises the step of triggering a Managed Patient Services (MPS) platform to facilitate performing a task pertaining to the selected option. Furthermore, the method comprises the step of embedding healthcare data and medical device data related to the task pertaining to the selected option within a device management protocol to create an information model. The method further comprises the step of transmitting the information model to a personal health gateway using the device management protocol. The method further comprises the step of receiving the information model by the personal health gateway. The method further comprises the step of transmitting the information model to one or more medical devices using the device management protocol. Furthermore, the method comprises the step of extracting the healthcare data and the medical device data embedded within the device management protocol. The method further comprises the step of performing the task pertaining to the selected option using the extracted healthcare data and the medical device data.

In an embodiment of the present invention, the task pertaining to the selected option comprises altering flow of data collection, adding questions to ask patient, managing workflow of patient therapy or treatment dynamically, updating medical device software, updating medical device firmware, installing new applications, monitoring health of battery, detecting bugs and faults, resetting device counters, configuring medical devices, allocating medical devices, de-allocating medical devices, requesting patient data, resetting medical device, locking medical device, facilitating medical device shutdown, facilitating medical device diagnostics, maintaining device backup, auditing/logging medical device, managing medical device faults or any other task related to medical device management or remote health management. In another embodiment of the present invention, the healthcare data comprises patient data, configuration files, software updates, firmware updates, or any other related healthcare data. In yet another exemplary embodiment of the present invention, the medical device data comprises device ID, device information, device details, or any other related medical device data.

A method for remote management of patients and medical devices is provided. In various embodiments of the present invention, the method comprises the step of selecting an option from one or more options provided by a user interface. Further, the method comprises the step of triggering a Managed Patient Services (MPS) platform to facilitate performing a task pertaining to the selected option. Furthermore, the method comprises the step of embedding healthcare data and medical device data related to the task pertaining to the selected option within a device management protocol to create an information model. The method further comprises the step of transmitting the information model to an aggregator using the device management protocol. The method further comprises the step of receiving the information model by the aggregator. Further, the method comprises the step of transmitting the information model to one or more medical devices using the device management protocol. Furthermore, the method comprises the step of extracting the healthcare data and the medical device data embedded within the device management protocol. The method further comprises the step of performing the task pertaining to the selected option using the extracted healthcare data and the medical device data.

In an embodiment of the present invention, the task pertaining to the selected option comprises altering flow of data collection, adding questions to ask patient, managing workflow of patient therapy or treatment dynamically, updating medical device software, updating medical device firmware, installing new applications, monitoring health of battery, detecting bugs and faults, resetting device counters, configuring medical devices, allocating medical devices, de-allocating medical devices, requesting patient data, resetting medical device, locking medical device, facilitating medical device shutdown, facilitating medical device diagnostics, maintaining device backup, auditing/logging medical device, managing medical device faults or any other task related to medical device management or remote health management. In another embodiment of the present invention, the healthcare data comprises patient data, configuration files, software updates, firmware updates, or any other related healthcare data. In yet another exemplary embodiment of the present invention, the medical device data comprises device ID, device information, device details, or any other related medical device data.

A method for remote management of patients and medical devices is provided. In various embodiments of the resent invention, the method comprises the step of measuring one or more patient's health parameters by one or more medical devices. Further, the method comprises the step of converting the measured one or more patient's health parameters into a predetermined healthcare protocol format to obtain healthcare data. Furthermore, the method comprises the step of embedding the medical device data and the healthcare data within a device management protocol to create an information model. The method further comprises the step of transmitting the information model to a Managed Patient Services (MPS) platform using the device management protocol. The method further comprises the step of extracting the healthcare data and the medical device data embedded within the device management protocol.

A method for remote management of patients and medical devices is provided. In various embodiments of the present invention, the method comprises the step of selecting an option from one or more options provided by a user interface. The method further comprises the step of triggering a Managed Patient Services (MPS) platform to facilitate performing a task pertaining to the selected option. Further, the method comprises the step of embedding healthcare data and medical device data related to the task pertaining to the selected option within a device management protocol to create an information model. Furthermore, the method comprises the step of transmitting the information model to one or more medical devices using the device management protocol. The method further comprises the step of extracting the healthcare data and the medical device data embedded within the device management protocol. The method further comprises the step of performing the task pertaining to the selected option using the extracted healthcare data and the medical device data.

In an embodiment of the present invention, the task pertaining to the selected option comprises altering flow of data collection, adding questions to ask patient, managing workflow of patient therapy or treatment dynamically, updating medical device software, updating medical device firmware, installing new applications, monitoring health of battery, detecting bugs and faults, resetting device counters, configuring medical devices, allocating medical devices, de-allocating medical devices, requesting patient data, resetting medical device, locking medical device, facilitating medical device shutdown, facilitating medical device diagnostics, maintaining device backup, auditing/logging medical device, managing medical device faults or any other task related to medical device management or remote health management. In another embodiment of the present invention, the healthcare data comprises patient data, configuration files, software updates, firmware updates, or any other related healthcare data. In yet another exemplary embodiment of the present invention, the medical device data comprises device ID, device information, device details, or any other related medical device data.

### BRIEF DESCRIPTION OF THE DRAWINGS

The present invention is described by way of exemplary embodiments illustrated in the accompanying drawings herein:

FIG. 1 is a block diagram illustrating a system for holistically managing medical devices and patients by embedding healthcare protocols within device management protocols in accordance with an embodiment of the present invention;

FIG. 2 is a detailed block diagram illustrating medical device having a management client residing in it in accordance with an embodiment of the present invention;

FIG. 3 is a detailed block diagram illustrating a personal health gateway in accordance with an embodiment of the present invention;

FIG. 4 is a detailed block diagram illustrating a managed patient services (MPS) platform in accordance with an embodiment of the present invention;

FIG. 5 is a management tree model illustrating an embedded 11073 Domain Information Model (DIM) node inside OMA DM tree in accordance with an embodiment of the present invention;

FIG. 6 is a management model illustrating an embedded HL7 Version 3.0 Reference Information Model (RIM) node inside OMA DM tree in accordance with an embodiment of the present invention; and

FIG. 7A and FIG. 7B is a flowchart illustrating a method for holistically managing medical devices and patients in accordance with an embodiment of the present invention.

### DETAILED DESCRIPTION

A system and method that provides a framework to holistically manage medical devices and patients by embedding healthcare protocols in one or more standard device management protocols. The invention provides a management platform to facilitate remote patient management and medical device management. Further, the present invention provides a standard way to holistically manage one or more medical devices incorporating different views such as the healthcare view and the device view that addresses system, maintenance, management, provisioning, configuration and other perspectives. Furthermore, the invention aims at providing standards based model for remote management of all kinds of medical devices, irrespective of the communication media used by plurality of such devices. The present invention facilitates incorporating healthcare standards such as ISO 11073, Health Level Seven (HL7), etc. with one or more device management protocols such as Simple Network Management Protocol (SNMP), Technical Report 069 (TR-069) and related TRs, Open Mobile Alliance Device Management (OMA DM), other machine to machine (M2M) protocols, and other management platforms and servers to create a complete information model. The invention provides a system to manage medical devices in a robust and efficient manner and adhere to required Service Level Agreements (SLAs). The invention further provides a personal health gateway as a common platform to connect to one or more medical devices. The personal health gateway may host various disease models abstracting out the one or more medical devices, from where the disease specific vitals are sourced. The invention provides an aggregator that facilitates to acquire, store, and transmit data from various medical devices. The aggregator may reside in the patient premise and/or in a healthcare facility. In addition, the invention provides a Managed Patient Services (MPS) platform that facilitates collaboration amongst providers, device manufacturers, insurance companies etc.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other exemplary embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of exemplary embodiments as illustrated in the accompanying drawings.

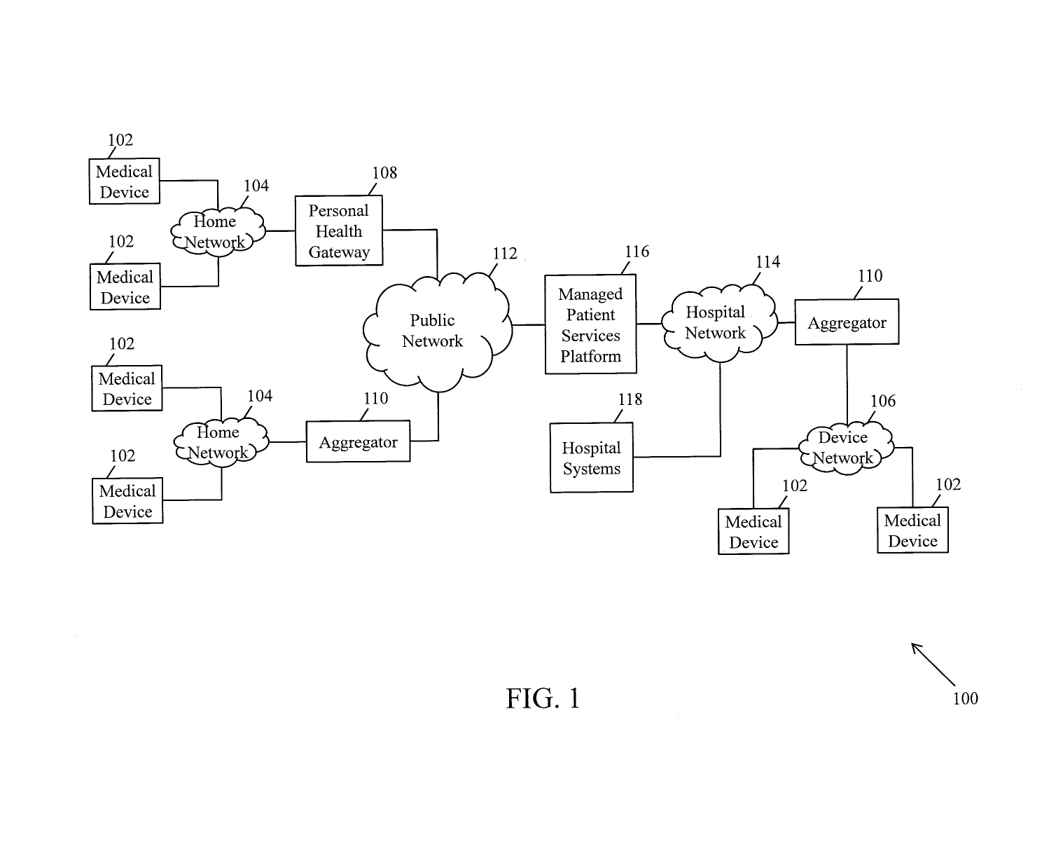

FIG. 1 is a block diagram illustrating a system for holistically managing medical devices and patients by embedding healthcare protocols within device management protocols in accordance with an exemplary embodiment of the present invention. The system 100 comprises one or more medical devices 102, a home network 104, device network 106, one or more personal health gateways 108, one or more aggregators 110, public network 112, hospital network 114, a Managed Patient Services (MPS) Platform 116, and hospital systems 118.

Medical device 102 is an instrument, apparatus, implement, machine, contrivance, implant, in vitro reagent, or other similar or related article including a component part, or accessory which is intended for use in the diagnosis of disease or other conditions, or in cure, mitigation, treatment, or prevention of disease. In various embodiments of the present invention, the medical device 102 may be an electronic device used for medical or health-related purposes in patients for diagnosis, therapy, surgery, and prevention and/or treatment of diseases. In an exemplary embodiment of the present invention, the medical device 102 may comprise a wide variety of electronic medical devices having various parameters that may be configured and managed using a management client residing in the medical device 102. In various exemplary embodiments of the present invention, the one or more medical devices 102 may consist of hardware that includes, but not limited to, sensors, processors, batteries, software, firmware and applications. Medical devices 102 includes a wide range of products varying in complexity and application such as, but not limited to, medical thermometers, blood sugar meters, artificial hearts, pulse generators, drug pumps, CT scanners, X-ray machines, MRIs, etc. In various embodiments of the present invention, the medical devices 102 measures patient vitals that includes patient's health parameters such as, but not limited to, blood sugar level, blood pressure, heart rate, temperature, etc. In an exemplary embodiment of the present invention, the medical device 102 may measure blood pressure of a patient. In another exemplary embodiment of the present invention, the medical device 102 may measure the heart rate of a patient. In various exemplary embodiments of the present invention, all the measured patient vitals are transmitted to the personal health gateway 108 or aggregator 110 via home network 104 or device network 106.

Home Network 104 is any wired or wireless communication network in a patient premise such as patient's home. The home network 104 facilitates communication between the medical devices 102, the personal health gateways 108 and/or the aggregators 110. In various exemplary embodiments of the present invention, the home network 106 includes, but not limited to, a Wi-Fi, a Bluetooth, ZigBee, Ethernet, Internet, and other last mile of service provider networks. In an exemplary embodiment of the present invention, the home network 104 is in a patient's home and receives measured patient vitals from one or more medical devices 102 for further transmission and analysis.

Device Network 106 is any wired or wireless communication network in a hospital or healthcare facility that facilitates communication between the medical devices 102 and the aggregator 110. In various exemplary embodiments of the present invention, the device network 106 includes, but not limited to, a Wi-Fi, a Bluetooth, ZigBee, Ethernet, USB and other serial ports. In an exemplary embodiment of the present invention, the device network 106 is in a hospital and receives measured patient vitals from one or more medical devices 102 for further transmission to aggregator 110. In another exemplary embodiment of the present invention, medical devices such as CT scanners, MRIs, X-ray machines etc. are connected to the aggregator 110 via the device network 106.

Personal health gateway 108 is an electronic communication device that facilitates communication between one or more medical devices 102 and MPS platform 116 via wired or wireless communication links. The one or more personal health gateways 108 interfaces to one or more medical devices 102 through the home network 104 and connects with the MPS platform 116 over the public network 112. The personal health gateway 108 has interface adapters and hardware ports to connect to the plurality of medical devices 102. The personal health gateway 106 may have one or more network ports such as Ethernet, ADSL, Wi-Fi, WLAN, RJ-45, USB, Bluetooth etc. In an embodiment of the present invention, the personal health gateway 108 receives the measured patient vitals from the one or more medical devices 102 via the home network 104. Further, the patient vitals are securely transferred to the MPS platform 116 via public network 112. In another embodiment of the present invention, the one or more personal health gateways 108 may implement the abstract disease models (for e.g., a diabetes model). In yet another embodiment of the present invention, the one or more personal health gateways 108 is an interactive communication device with the patient. A doctor may post a question to the patient which gets reflected on the personal health gateway 108 through the MPS platform 116.

The aggregator 110 is hardware and/or software product that acquires, transfers, stores, converts format, and enables displaying of medical device data. The aggregator 110 may include, but not limited to, Medical Device Data Systems (MDDS). In various exemplary embodiments of the present invention, the aggregator 110 may comprise software that may store patient data and convert medical data into a format that can be printed and/or displayed. In an exemplary embodiment of the present invention, the aggregator 110 may store patient's blood pressure readings for review at a later time. In another exemplary embodiment of the present invention, the aggregator 110 may convert digital data generated by a pulse oximeter into a format that can be printed. In yet another exemplary embodiment of the present invention, the aggregator 110 may process a previously stored electrocardiogram of a particular patient and render it on the display. In various embodiments of the present invention, the measured patient vitals may be transmitted by the aggregator 110 to the MPS platform 116 via the public network 112. The aggregator 110 may also push the EMR to the actual EMR server directly or through the MPS platform 116. In yet another exemplary embodiment, the aggregator 110 may act as a proxy management client for battery and CPU of critical implantable devices.

In an embodiment of the present invention, the aggregator 110 connects with one or more medical devices 102 through its communication interfaces. The aggregator 110 is notified about one or more new medical devices by the MPS platform 116. Further, the medical device profiles are stored in the device profiles repository of the aggregator 110. Furthermore, the MPS platform 116 initiates transfer and installation of medical device drivers and applications to facilitate connection of the aggregator 110 with the one or more new medical devices 102.

In various embodiments of the present invention, the aggregator 110 acquires and aggregates data such as measured patient's health parameters, patient vitals, medical device data, etc. from one or more medical devices 102 through its communication interfaces. It converts the acquired data into appropriate healthcare protocol format for e.g. 11073 or HL7 to obtain appropriate healthcare data. Further, the aggregator 110 facilitates creating an information model by embedding the medical device data and the healthcare data within a device management protocol. The information model is a formal representation of entity types that includes their properties, relationships, and the operations that can be performed on them. The entity types may include, but not limited to, medical devices, personal health gateways, and aggregators. Furthermore, the information model comprises metadata information, such as patient id, provider id, Doctor in charge etc. The information model is transmitted to the MPS platform 116 using the device management protocol.

In an exemplary embodiment of the present invention, the personal health gateway 108 or the aggregator 110 may function as a proxy management client on behalf of the one or more medical devices 102 such as, but not limited to, implantable medical devices wherein a management client cannot be implemented full-fledged. The personal health gateway 108 or aggregator 110 realizes the instrumentation layers through wireless or proprietary radio/telemetry modes of communication.

The public network 112 is a wired or wireless communications network. The public network 112 facilitates communication between one or more personal health gateways 108 or one or more aggregators 110 (residing at patient premise) and MPS platform 112. The public network 112 may be a secure communication network. In various exemplary embodiments of the present invention, the public network 112 may include, but not limited to, a Wide Area Network (WAN), Internet, Virtual Private Network (VPN), etc. In an embodiment of the present invention, the public network 112 receives all the measured patient vitals from the personal health gateways 108 and aggregators 110 residing at the patient's premise. Further, the public network 112 transmits the received patient vitals to MPS platform 116 for analysis.

The hospital network 114 is wired or wireless communications network in a hospital or a healthcare facility interconnecting various information systems and devices. The hospital network 114 facilitates communication between one or more aggregators 110 residing in a hospital or healthcare facility and MPS platform 116. The hospital network 114 may be a secure communications network. In various exemplary embodiments of the present invention, the hospital network 114 includes, but not limited to, secure hospital network, Virtual Private Network (VPN), encrypted networks, etc. In an embodiment of the present invention, the hospital network 114 receives all the measured patient vitals from the aggregators 110 residing in a hospital or a healthcare facility. Further, the hospital network 110 transmits the received patient vitals to MPS platform 116 for analysis.

The Managed Patient Services (MPS) platform 116 is a server facilitating medical device management, gateway management, aggregator management, patient management and integration and interoperability with Hospital systems, Payer systems etc. The MPS platform 116 manages one or more medical devices 102 by embedding healthcare protocols within standard device management and communication protocols such as OMA-DM, TR-069, or SNMP. In various exemplary embodiments of the present invention, the MPS platform 116 may facilitate medical device management operations including, but not limited to, device configuration, provisioning, software updates, firmware updates, installation of new applications, device diagnostics etc. In an exemplary embodiment of the present invention, the medical device parameters may be configured by the healthcare practitioners as per patient's need. In another exemplary embodiment of the present invention, the software updates or firmware updates may be performed on one or more medical devices 102 by the Original Equipment Manufacturer (OEM) or the service provider through the MPS Platform 116 using an electronic communication device. In various embodiments of the present invention, the electronic communication device facilitates the user to access MPS platform 116. The electronic communication device may include, but not limited to, a mobile phone, handheld electronic device, laptop, desktop, etc. In yet another exemplary embodiment of the present invention, a hospital may rent medical devices from a service provider and have an account on MPS platform 116 hosted by the service provider. The hospital through the MPS platform 116 may assign one or more medical devices 102, one or more personal health gateways 108 and/or one or more aggregators 110 to a patient for a specific period.

In an alternate embodiment of the present invention, the one or more medical devices 102 may bypass the personal health gateway 108 or aggregator 110 to directly connect with the MPS platform 116. In an embodiment of the present invention, the one or more medical devices 102 may reside in a patient premise and connect with the MPS platform 116 via the public network 112. In another embodiment of the present invention, the one or more medical devices 102 may reside in a healthcare facility and connect with the MPS platform 116 via the hospital network 114. The medical device 102 acquires and aggregates data such as measured patient's health parameters, patient vitals, medical device data, etc. It converts the acquired data into appropriate healthcare protocol format for e.g. 11073 or HL7. Further, a management client residing in the medical device 102 facilitates creating an information model by embedding the medical device data and the healthcare data within a device management protocol. The information model is a formal representation of entity types such as, but not limited to, medical device 102 that includes its properties, relationships, and the operations that can be performed on them. Furthermore, the information model comprises metadata information, such as patient id, provider id, doctor in charge etc. The information model is transmitted to the MPS platform 116 using the device management protocol.

In an embodiment of the present invention, the MPS platform 116 may also facilitate remote health management and patient management operations including, but not limited to, dynamic workflow management of patient therapy/treatment, downloading patient historic data, collecting patient vitals, posting questions to patient's personal health gateway, altering the flow of data collection, etc.

In various exemplary embodiments of the present invention, the MPS platform 116 may have management services layers such as a managed service application layer or a simple administration layer to facilitate remote health management and medical device management. The MPS platform 116 may either be run by a service provider in a hosted multi tenancy model (cloud) or can be hosted by a healthcare provider for exclusive use. Further, the MPS platform 116 may have interfaces to communicate with personal health gateways 108 and the aggregators 110. Furthermore, the MPS platform 116 may have interconnections between various hospital systems 118 such as Electronic Medical Records (EMRs), Hospital Management System (HMSs), EMR Integration Engines, Edge devices, Health Exchanges, government sponsored health networks etc. In addition, the MPS platform 116 may have healthcare provider portals, administration portals, service provider portals, patient portals, MPS portal, etc. that may be accessed using an electronic communication device. In an embodiment of the present invention, the MPS platform 116 provides an MPS portal through which the user selects the URL for appropriate user portal such as, but not limited to, healthcare provider portal, service provider portal, patient portal, etc. In another embodiment of the present invention, the user may directly enter the web address to access a particular portal using his electronic communication device. In yet another embodiment of the present invention, the portals provided by MPS platform 116 may be accessed using the personal health gateway 108.

In an exemplary embodiment of the present invention, the MPS platform 116 may facilitate the service provider to assign one or more personal health gateways 108 or one or more aggregators 110 to a patient. The service provider may update the graphical user interface (GUI) for a medical device 102 by installing new GUI software through the MPS platform 116. The service provider may also apply a software patch to fix a problem in one or more medical devices 102.

In another exemplary embodiment of the present invention, the healthcare practitioner may configure the medical device 102 so as to increase the flow of air in a flow generator or disable/enable flow generator as per therapy needs of a patient through the MPS platform 116. The healthcare practitioner may also add one or more questions using his electronic communication device to be answered by the patient through the MPS platform 116, which gets reflected on the patient's personal health gateway 108. In another exemplary embodiment of the present invention, the nurse or care giver may collect patient specific vitals such as blood pressure or temperature at regular intervals through the MPS platform 116. In yet another exemplary embodiment of the present invention, the MPS platform 116 may also facilitate updating device profiles in case new medical devices 102 are discovered by one or more personal health gateways 108 and/or one or more aggregators 110. The MPS platform may facilitate transfer and installation of medical device communication drivers to one or more personal health gateway 108 and one or more aggregators 110.

In an exemplary embodiment of the present invention, the MPS platform 116 facilitates access to hospital systems 118. In various exemplary embodiments of the present invention, the MPS platform 116 facilitates managing each class of medical devices 102 irrespective of the communication media used by the plurality of such medical devices. In another exemplary embodiment of the present invention, the MPS platform 116 can process the collected patient vitals and create an Electronic Medical Record (EMR) and transfer it to the EMR server hosted by the Healthcare Provider. In yet another exemplary embodiment of the present invention, the MPS platform 116 is integrated with a healthcare provider's EMR and the user interfaces provided by the MPS platform 116 are presented in the EMR to perform various patient and medical device management tasks using mechanisms such as Single Sign-On (SSO) mechanism.

The hospital systems 118 includes one or more hospital servers, Hospital Management System (HMS), Electronic Medical Records (EMRs), Hospital Information Systems (HISs), data storages, Clinical Information Systems (CISs), healthcare information systems, patient data management systems, ERPs for other operations and administrations of the hospital, etc. The MPS platform 116 provides interface to facilitate interconnection between various hospital systems 118 via the hospital network 114. In various embodiments of the present invention, data storages and hospital systems 118 such as, but not limited to, patient data management systems, EMRs and CISs may store the measured patient vitals. In an exemplary embodiment of the present invention, the hospital may hook their HMS and EMRs application to the MPS platform 116 to source patient monitored data from the MPS platform 116 and to configure the disease profiles or medical devices 102. Further, the measured patient vitals and patient data originating from the one or more medical device 102 is transmitted to the healthcare provider's EMR. In another exemplary embodiment of the present invention, a doctor may post a question to the patient through the EMR, which gets reflected on the patient's personal health gateway 108 through the MPS platform 116. In yet another exemplary embodiment of the present invention, aggregators 110 or personal health gateways 108 may communicate with the hospital systems 118 directly or through the MPS platform 116.

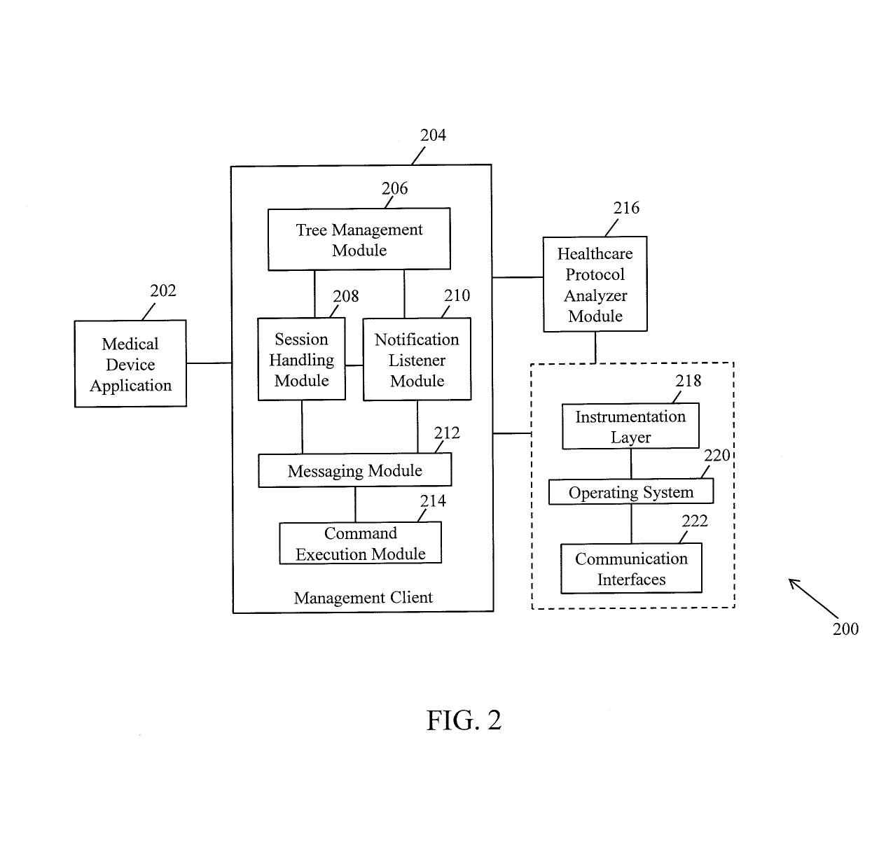

FIG. 2 is a detailed block diagram illustrating a medical device having a management client residing in it, in accordance with an embodiment of the present invention. The medical device 200 comprises medical device application 202, management client 204, healthcare protocol analyzer module 216, instrumentation layer 218, operating system 220 and communication interfaces 222.

The medical device application 202 is a software program that provides an interface to the user to perform one or more tasks on medical device 200. The medical device application 202 controls the core functions of the medical device with respect to how it is intended to perform. In various exemplary embodiments of the present invention, the medical device application 202 may include, but not limited to, an application suite or a graphical user interface. In an exemplary embodiment of the present invention, the medical device application 202 may facilitate the user to manage various tasks such as, measuring patient's health parameters, monitoring health parameters, selecting various device modes, updating user profile, etc. In another exemplary embodiment of the present invention, the patient may be able to view his measured health parameters through the medical device application 202. In yet another exemplary embodiment of the present invention, the patient may interact with the medical device 200 using the medical device application 202.

The management client 204 is a software module residing in the medical device 200 which facilitates client side implementation of the device management specification. The management client 204 facilitates various services including, but not limited to, connection to MPS platform 116 (FIG. 1) via personal health gateway 108 (FIG. 1) or the aggregator 110 (FIG. 1), performing authentication of the connected MPS platform, parsing the received protocol messages, etc. In an exemplary embodiment of the present invention, the management client 204 establishes a communication session with MPS platform over a transport layer and device management protocol. In addition, a management client 204 provides information to MPS platform related to the features of the client device, such as device model, manufacturer, etc. In various exemplary embodiments of the present invention, the management client 204 facilitates embedding and extracting healthcare data and medical device data embedded within a device management protocol.

The management client 204 comprises of tree management module 206, the session handling module 208, the notification listener module 210, the messaging module 212, and the command execution module 214. In an embodiment of the present invention, the management client 204 is implemented as a proxy client on the personal health gateway and/or the aggregator for devices such as, but not limited to, implantable devices where it is not possible to implement management client inside the device due to its limited processing capabilities or other considerations.

The tree management module 206 is a software module that manages the management tree which facilitates medical device abstraction. The medical device 200 can be viewed as a hierarchical tree structure where the nodes and leaf nodes of the management tree are the device settings and the leaf node values are the device setting values. The management tree represents all available information of the medical device 200. The nodes are accessed by specifying a hierarchical path to the node, called the Universal Resource Identifier (URI), starting at the root. The health related parameters are embedded as a node inside the management tree managed by the tree management module 206. In various exemplary embodiments of the present invention, the management tree facilitates medical device management and remote health management. In an exemplary embodiment of the present invention, the ISO 11073 specification may be implemented as a node inside the management tree. In another exemplary embodiment of the present invention, the management tree, apart from abstracting the medical device functions, may be used in the aggregator or the personal health gateway to create disease profiles.

The session handling module 208 is a software module that manages the client-server communication sessions. The session handling module 208 manages the communication session which is a request-response protocol between management client 204 and MPS platform 116 (FIG. 1) through the personal health gateway 108 (FIG. 1) or aggregator 110 (FIG. 1). In an exemplary embodiment of the present invention, the session handling module 208 may authenticate the MPS platform to ensure that the management client 204 and the MPS platform communicate after proper validation. In another exemplary embodiment of the present invention, the session handling module 208 handles the communication session established between the MPS platform and management client to ensure that messages are exchanged to complete a medical device management transaction. In yet another exemplary embodiment of the present invention, the session handling module 208 may also handle sessions triggered by alerts that can occur out of sequence, and can be initiated by either MPS platform or management client. Such alerts are used to handle errors, abnormal terminations etc.

The notification listener module 210 is a software module that receives initial messages from the MPS platform such as, but not limited to, notification or alert message to commence a client-server session, asynchronous messages from the MPS platform requesting specific action, etc. In an exemplary embodiment of the present invention, the communication may be initiated by the MPS platform using any of the methods available including, but not limited to, SMS or a Wireless Application Protocol (WAP) Push.

The messaging module 212 handles communication between medical device and the server. The messaging module 212 parses the incoming messages from the MPS platform to execute medical device management tasks. Further, the messaging module constructs protocol units for sending out messages to the MPS platform. The messaging module 212 parses the incoming message from the MPS platform and transmits to the command execution module 214. In an embodiment of the present invention, the messaging module 212 may parse the incoming messages in order to execute the command for appropriate management task.

The command execution module 214 is a software module to identify the management task to be performed and execute related commands to the instrumentation layer 218 or the healthcare protocol analyzer 216. The command execution module 214 directly sends non-healthcare specific commands to the instrumentation layer 218. Further, the command execution module 214 forwards messages that are encoded in a healthcare protocol to healthcare protocol analyzer 216.

The healthcare protocol analyzer module 216 is a software module which facilitates analyzing the healthcare protocol data extracted by the management client 204 to make appropriate instrumentation requests to instrumentation layer 218. In various embodiments of the present invention, there may be protocol analyzers for various healthcare protocols including, but not limited to, protocol analyzer for 11073, protocol analyzer for HL7, etc.

The instrumentation layer 218 is a software layer which facilitates implementation of services from the MPS platform to the hardware of medical device 200 and is independent of device management or healthcare protocol implementations such as 11073 or HL7 etc. Further, the instrumentation layer 218 keeps the tree management module 206 updated related to various states on the medical device 200. Furthermore, the instrumentation layer 218 provides data to the management client 204 that reflects the state of hardware of the medical device 200. In various exemplary embodiments of the present invention, the instrumentation layer 218 is responsible for configuring operations from the MPS platform to the actual medical device hardware.

The operating system 220 is the system software for execution of various software applications and to manage various hardware resources of the medical device 200. The operating system 220 controls various operations of the medical device 200. In an exemplary embodiment of the present invention, Application-Specific Integrated Circuit (ASIC) for various implantable devices or tiny devices may be used doing away with a full-fledged operating system.

Communication interfaces 222 are the communication ports of the medical device 200 that facilitate wired or wireless connections with networks, servers or other devices. The medical device 200 interacts with one or more personal health gateways 108 (FIG. 1) and one or more aggregators 110 (FIG. 1) through the communication interfaces 222. In an exemplary embodiment of the present invention, the communication interfaces 222 may include, but not limited to, Bluetooth, Wi-Fi, USB, Ethernet, Zigbee, etc.

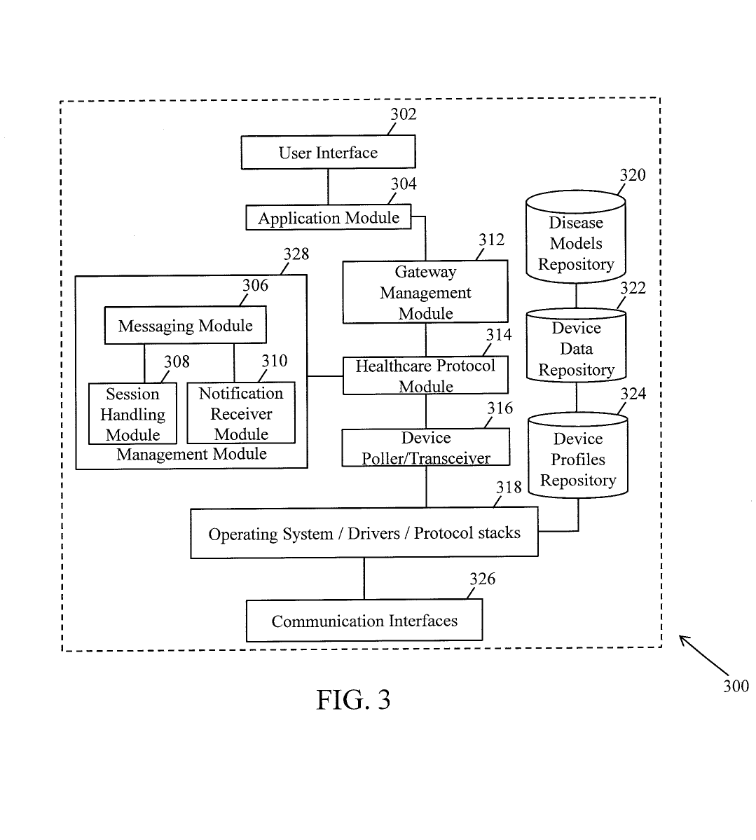

FIG. 3 is a detailed block diagram illustrating a personal health gateway in accordance with an embodiment of the present invention. The personal health gateway 300 comprises user interface 302, application module 304, gateway management module 312, healthcare protocol module 314, device poller/transceiver 316, operating system/drivers/protocol stacks 318, disease models repository 320, device data repository 322, device profiles repository 324, communication interfaces 326 and management module 328. The management module 328 further comprises messaging module 306, session handling module 308, and notification receiver module 310.

The user interface 302 is a front end interface that provides various options to the user to facilitate communication with the personal health gateway 300. In an exemplary embodiment of the present invention the user interface 302 may be a graphical user interface having icons, windows, pop-up menus, etc. to facilitate the patient to interact with the personal health gateway 300 and perform appropriate tasks. In various exemplary embodiment of the present invention, the user interface 302 may include, but not limited to, a Graphical User Interface (GUI), touch screen, web-based user interface, etc. In another exemplary embodiment of the present invention, the healthcare practitioner may post a question to the patient which gets reflected on the user interface 302. Further, the patient may answer a question posted by healthcare practitioner through the user interface 302. In yet another exemplary embodiment of the present invention, the patient may select a different disease model to measure additional health parameters.

The application module 304 is a software program that provides an interface to one or more users to perform various medical device and patient management operations. The application module 304 is the software program that provides the user interface 302. In various embodiments of the present invention, application module 304 may include, but not limited to, application suite, portal, web portal, etc.

The management module 328 comprises messaging module 306, session handling module 308, and notification receiver module 310.

The messaging module 306 handles communication between the medical device and the MPS platform. The messaging module 306 acquires data such as, measured patient's health parameters, patient vitals, medical device data, etc. from the medical device 102 (FIG. 1) through the communication interfaces 326. Further the messaging module 306 converts the acquired data into appropriate 11073 or other healthcare protocol formats using healthcare protocol module 314 and then constructs appropriate device management protocol units for sending out messages to the MPS platform 116 (FIG. 1).

The session handling module 308 is a software module that manages the client-server communication sessions. The session handling module 208 manages the communication session which is a request-response protocol between medical device 102 (FIG. 1) and MPS platform 116 (FIG. 1) through the personal health gateway 300. In an exemplary embodiment of the present invention, the session handling module 308 handles the communication session established between the MPS platform and the medical device to ensure that messages are exchanged to complete a device management or remote health management task. In another exemplary embodiment of the present invention, the session handling module 308 may also handle sessions triggered by alerts that can occur out of sequence, and can be initiated by either MPS platform or medical device.

The notification receiver module 310 is a software module that receives initial messages from the MPS platform in the form of a notification or alert message. In an exemplary embodiment of the present invention, the communication may be initiated by the MPS platform using any of the methods available including, but not limited to, a Wireless Application Protocol (WAP) Push or SMS.

The gateway management module 312 controls and manages the personal health gateway 300. In an embodiment of the present invention, the gateway management module 312 may initiate device management commands for itself. In another embodiment of the present invention, the gateway management module 312 may initiate device management commands to connect a new medical device.

The healthcare protocol module 314 is a software module that converts acquired medical data into appropriate healthcare protocol formats. In various embodiments of the present invention, there may be separate healthcare protocol modules 314 for various healthcare protocols including, but not limited to, 11073 protocol module, h17 protocol module, etc.

The device poller/transceiver 316 is a software that facilitates handshake with one or more medical devices through appropriate communication channel. In an embodiment of the present invention, the device poller/transceiver 316 identifies new medical device and handshakes with the medical device to establish a communication session with it.

The operating system/drivers/protocol stacks 318 are the system software and hardware for execution of various software applications and to manage various hardware resources of the personal health gateway 300. The operating system/drivers/protocol stacks 318 controls all the operations of the personal health gateway 300.

Disease models repository 320 is a storage or memory to store data related to various disease models including, but not limited to, diabetes model, cardiac model, self-care model, etc. The disease model repository 320 stores vitals that make up the disease model. There are separate disease models for various different diseases. The disease models may be customized for a particular patient by the healthcare provider through MPS platform 116 (FIG. 1).

Device data repository 322 is a storage or memory to store data received from one or more medical devices connected to personal health gateway 300. Device data repository 322 stores the data including, but not limited to, measured patient vitals, measurement timings, device mode, etc.

Device profiles repository 324 is a storage or memory to store metadata related to one or more medical devices 102 connected to personal health gateway 300. In an exemplary embodiment of the present invention, the data stored in device profiles repository 324 may include information related to one or more medical devices such as device operating system, installed applications, hardware and software components, interfaces, protocols, device drivers etc. In another exemplary embodiment of the present invention, the MPS platform may initiate transfer and installation of device driver at device profiles repository 324 to create a new device profile. The device profiles repository 324 facilitates connection to medical devices it supports and accommodates newer medical devices.

Communication interfaces 326 are the communication ports of the personal health gateway 300 which facilitates wired or wireless connections with networks, servers or medical devices. Communication interfaces 326 facilitate connection with plurality of medical devices 102 (FIG. 1) and MPS platform 116 (FIG. 1). In various exemplary embodiments of the present invention, communication interfaces 326 may include, but not limited to, Wi-Fi, USB, Ethernet, Zigbee, Bluetooth, GSM, Modem etc.

In various embodiments of the present invention, the personal health gateway 300 receives data such as measured patient's health parameters, patient vitals, medical device data, etc. from one or more medical devices 102 (FIG. 1) through communication interfaces 326. It converts the received data into appropriate healthcare protocol format for e.g. ISO 11073 or HL7 using healthcare protocol module 314 to obtain healthcare data. Further, the personal healthcare gateway 300 creates an information model by embedding the healthcare data and the medical device data within a device management protocol. The information model also contains other metadata information, such as patient id, provider id, doctor in charge etc. Furthermore, the information model is then transmitted to the MPS platform 116 (FIG. 1) by the communication interfaces 326 using the device management protocol.

In an embodiment of the present invention, the personal health gateway 300 connects with one or more medical devices 102 (FIG. 1) through communication interfaces 326. The personal health gateway 300 is notified about one or more new medical devices by the MPS platform. Further, the medical device profiles are stored in the device profiles repository 324. The MPS platform notifies one or more personal health gateways 300 about one or more new medical device profiles. Furthermore, the MPS platform initiates transfer and installation of medical device drivers and applications to facilitate connection of personal health gateway 300 with the one or more new medical devices.

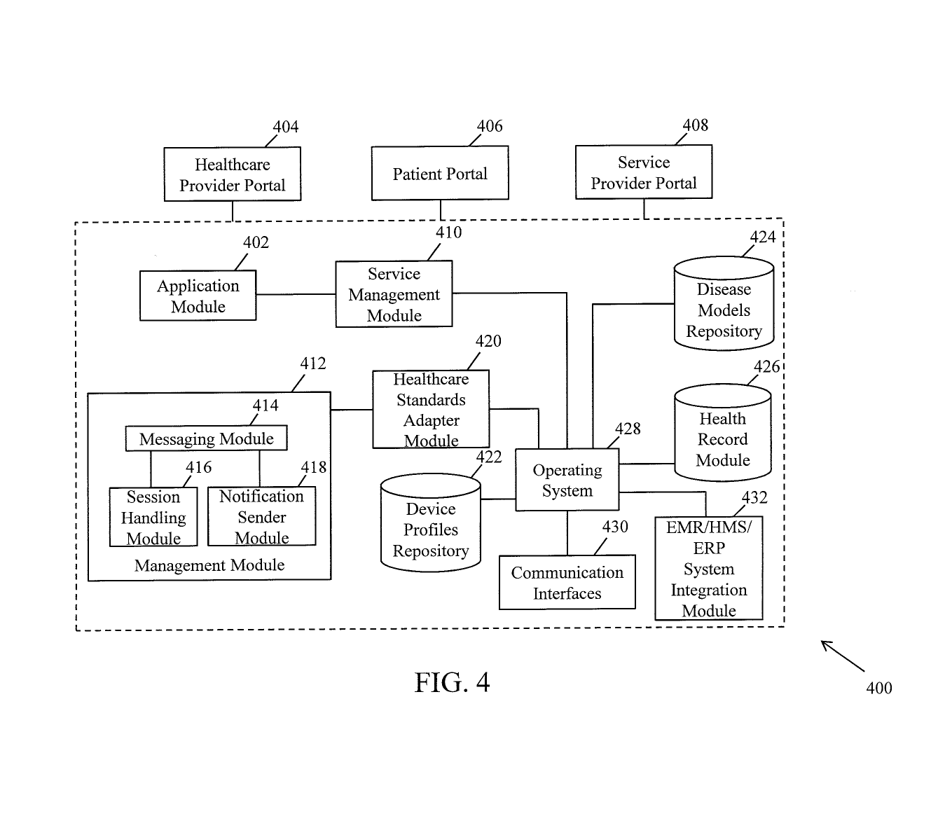

FIG. 4 is a detailed block diagram illustrating the Managed Patient Services (MPS) platform in accordance with an embodiment of the present invention. The MPS platform 400 comprises an application module 402, healthcare provider portal 404, patient portal 406, service provider portal 408, service management module 410, management module 412, messaging module 414, session handling module 416, notification sender module 418, healthcare standards adapter module 420, device profiles repository 422, disease models repository 424, health records module 426, operating system 428, communication interfaces 430, EMR/HMS/ERP system integration module 432.

The application module 402 is a software program that provides interface to one or more users to perform various tasks pertaining to medical device and patient management. The application module 402 provides an interface to the user to access the MPS platform 400 using electronic communication devices including, but not limited to, a laptop, mobile phone, desktop, palmtop, personal health gateway, etc. In various embodiments of the present invention, the user may include, but not limited to, a service provider, healthcare provider, patient, caregiver, nurse, device manufacturer/OEM, hospital personnel, etc. In an exemplary embodiment of the present invention, the application module 402 may be a user interface including, but not limited to, portal, web portal, application suite, MPS portal, healthcare provider portal, service provider portal, administration portal, patient portal, etc. In another exemplary embodiment of the present invention, a hospital may deploy its own application module 402 to differentiate from the other healthcare providers. In yet another exemplary embodiment of the present invention, the user may visit the MPS portal and select a Universal Resource Locator (URL) to access a particular user portal, such as, but not limited to, patient portal, healthcare provider portal, service provider portal, etc. In yet another embodiment of the present invention, the user may directly enter the web address of the appropriate portal provided by MPS platform 400 using his electronic communication device or personal health gateway.

The healthcare provider portal 404 is a user interface for healthcare provider to access various options provided by MPS platform to perform one or more tasks. The healthcare provider 404 includes, but not limited to, a healthcare practitioner, nurse, care giver, hospital personnel, healthcare personnel, doctor, etc. The healthcare provider portal 404 provides appropriate options to the healthcare providers to perform various tasks including, but not limited to, modifying workflow, modifying disease profiles, accessing patient data, allocating/de-allocating medical devices 102 (FIG. 1) or personal health gateways 108 (FIG. 1) or aggregators 110 (FIG. 1) to patients, configuring medical devices, etc. The healthcare provider portal 404 may be graphical user interface, touch screen interface, character user interface, web based user interface, etc. In various exemplary embodiments of the present invention, the healthcare practitioner may modify workflow, including but not limited to, vitals collection sequence, dynamic personalized questions etc. through the healthcare provider portal 404 using his electronic communication device. In an exemplary embodiment of the present invention, the healthcare practitioner may remove the task “collect weight data” from a patient's workflow which gets configured on the patient's personal health gateway and the personal health gateway intelligently stops asking the patient to stand on the weighing scale. In another exemplary embodiment of the present invention, the healthcare provider portal 404 may provide information such as number of medical devices, personal health gateways, and aggregators rented from a service provider.

The patient portal 406 is a user interface for the patients to access various options provided by the MPS platform. The patient portal 406 includes, but not limited to, graphical user interface, touch screen interface, web based user interface, character user interface, etc. In an embodiment of the present invention, the patient may access data such as list of assigned medical devices and/or personal health gateways and/or aggregators, historic device data, etc. through the patient portal 406. This data can be directly transmitted to the EMR of the healthcare provider.

The service provider portal 408 is a user interface for service provider to access various options provided by MPS platform to perform one or more tasks. The service provider portal 408 includes, but not limited to, graphical user interface, touch screen interface, web based user interface, character user interface, etc. The service provider portal 408 provides appropriate options to the service provider to perform various tasks including, but not limited to, managing and configuring one or more medical devices, allocating/de-allocating medical devices, personal health gateways and aggregators to patients or healthcare provider, updating software or firmware of one or more medical devices, installing software applications on one or more medical devices, resetting counters of one or more medical devices, detecting bugs and faults in medical devices, monitoring health of battery of medical devices, etc. The service provider may include, but not limited to, OEMs, service engineers, vendors, service technicians, other representatives and service personnel etc. In an exemplary embodiment of the present invention, the service provider may access the service provider portal 408 using his electronic communication device to allocate one or more medical devices to a healthcare provider. In another exemplary embodiment of the present invention, the service provider may schedule mass upgrades or batch updates for medical devices by accessing service provider portal 408.

In various exemplary embodiments of the present invention, there may be various other user interfaces to provide access to different categories of users such as administration, management, IT management, etc. In an embodiment of the present invention, there may be an IT management portal providing all such functions needed for the system to run in a physical/virtual data center. In another embodiment of the present invention, an administrator may access administrator portal to facilitate related administrative tasks.

The service management module 410 is a software module which facilitates management of various services pertaining to disease profile management, medical device management, patient management etc. The service management module 410 is deployed on the MPS platform 400 as required by the healthcare provider or the service provider. In various embodiments of the present invention, the service management module 410 facilitates generic functionality as envisioned by the service provider. In an exemplary embodiment of the present invention, the service provider may deploy services based on the medical devices and the type of services offered to the patients by the healthcare provider. In various embodiments of the present invention, the service management module 410 may facilitate managing batch upgrade jobs, grouping medical devices, allocation and de-allocation of medical devices etc. In an embodiment of the present invention, the service management module 410 may facilitate management of services such as, but not limited to, diabetes management, cardiac management, weight management, etc.

The management module 412 is a software module implementing the server side functionalities defined in the device management specifications. The management module facilitates medical device management and remote health management. The management module 412 comprises messaging module 414, session handling module 416, and notification sender module 418.

The messaging module 414 handles communication between medical devices 102 (FIG. 1), personal health gateways 108 (FIG. 1), aggregators 110 (FIG. 1), and the MPS platform 400. The messaging module parses the incoming messages from the medical device 102 through the personal health gateway 108 and/or aggregators 110 to perform appropriate device and remote health management tasks. Further the messaging module 414 constructs protocol units by embedding healthcare data within a device management protocol for sending out messages to the one or more medical devices through the personal health gateway or aggregator or directly. In various embodiments of the present invention, the messaging module 414 facilitates extracting the healthcare data embedded within the device management protocol transmitted by the one or more medical devices through the aggregator and/or personal health gateways.

The session handling module 416 is a software module that manages the client-server communication session. The session handling module 416 manages the communication session which is a request-response protocol between the medical device and the MPS platform through the personal health gateway or aggregator. The communication session may be initiated by the MPS platform managed by the session handling module 416. The initial message from the MPS platform to management client 204 (FIG. 2) may be a notification or an alert message. In an exemplary embodiment of the present invention, the session handling module 416 handles the communication session between the MPS platform and the medical devices to ensure sequence of messages may be exchanged to complete a medical device management and/or remote health management task. In yet another exemplary embodiment of the present invention, the session handling module 416 may also handle sessions triggered by alerts that can occur out of sequence, and can be initiated by either MPS platform or medical device.

The notification sender module 418 is a software module that facilitates sending notifications to the one or more medical devices. The notification sender module 418 facilitates sending notification or alerts initiated by MPS platform to one or more medical devices via personal health gateways or aggregators. In an exemplary embodiment of the present invention, the communication may be initiated by the MPS platform using any of the methods available including, but not limited to, an SMS or a WAP push.

The healthcare standards adapter module 420 is a protocol adapter that maps operations from MPS platform to the medical device and hospital systems as per the required healthcare standards protocol. The healthcare standards adapter module 420 converts the data received from one or more medical devices via one or more personal health gateways and one or more aggregator into appropriate healthcare protocols. In various embodiments of the present invention, there may be separate healthcare standards adapter modules 420 for various healthcare protocols including, but not limited to, 11073 standards adapter module, h17 standards adapter module, etc.

Device profiles repository 422 is a repository to store metadata related to one or more medical devices. The device profiles repository 422 stores information about one or more medical devices 102 (FIG. 1). Further, the device profiles repository 422 enables the system to take cognizance of all the medical devices it supports. In an exemplary embodiment of the present invention, the data stored in device profiles repository 422 may include information related to one or more medical devices such as operating system, installed applications, hardware and software components, interfaces, protocols, device model, serial number, serial name, installed application, firmware version number, etc. In another exemplary embodiment of the present invention, new medical device profiles may be configured and stored in the device profile repository 422 by the service provider or healthcare provider through the service provider portal 408 or healthcare provider portal 404 respectively.

Disease models repository 424 is a repository to store data related to various disease models. There are separate disease models for various diseases. In an embodiment of the present invention, the disease models repository 424 stores vitals that make up the disease models. The disease models may be customized for a particular patient by the healthcare provider through healthcare provider portal 404.

Health record repository 426 is a storage or memory to store data related to patients. In an embodiment of the present invention, a patient may access his therapy/treatment record by accessing the MPS platform 400 through the patient portal 406. In another exemplary embodiment of the present invention, the Health record repository 426 may only store data necessary to maintain patient identification and historic readings from the medical device and fetch data directly from the healthcare provider's EMR or HIS. The MPS platform may implement software modules to convert data collected from the aggregator or the personal health gateway into a complete Medical record and send it to the EMR, which happens to be the master health record repository for the healthcare provider.

The operating system 428 is the software for execution and managing various software applications and various hardware resources of the MPS platform 400. The operating system 428 controls all the operations of the MPS platform 400.

Communication interfaces 430 are the communication ports of the MPS platform 400 which facilitates wired or wireless connections with networks, servers or other devices. Communication interfaces 430 facilitates connection with one or more personal health gateways 108 (FIG. 1) and one or more aggregators 110 (FIG. 1). In various exemplary embodiments of the present invention, communication interfaces 430 include, but not limited to, Wi-Fi, USB, Ethernet, optical network, etc.

EMR/HMS/ERP system integration modules 432 are the communication and system integration interfaces for hospital systems. In various embodiments of the present invention, EMR/HMS/ERP system integration modules 432 may have interfaces for systems including, but not limited to, hospital servers, HMS, EMRs, HIS, data storages, CISs, healthcare information systems, patient data management systems, ERPs for other operations and administrations of the hospital etc. In an exemplary embodiment of the present invention, the EMR/HMS/ERP system integration modules 432 may include, but not limited to, Ethernet, optical network, USB, etc.

In various embodiments of the present invention, the user may select an option provided by the user portal such as, but not limited to, healthcare provider portal 404, patient portal 406, service provider portal 408, etc. In addition, the MPS platform 400 facilitates performing tasks related to medical device management and remote health management pertaining to the option selected by the user through the user interface. In an embodiment of the present invention, the medical device management includes tasks such as, but not limited to, updating medical device software, updating medical device firmware, installing new device applications, monitoring health of battery, batch upgrades, detecting bugs and faults, resetting device counters, configuring medical devices, allocating medical devices, de-allocating medical devices, requesting patient data, device reset/lock/shutdown, device diagnostics, device backup, device auditing/logging, device fault management or any other task related to device management. Further, the remote health management includes tasks such as, but not limited to, dynamic workflow management of patient therapy/treatment, altering flow of patient data collection, adding questions to ask patient, answering questions posted by healthcare practitioner, accessing patient profiles, allocating or de-allocating medical devices, personal health gateways and the aggregators, resetting counters of medical devices, personal health gateways, and the aggregators or any other task related to remote health management or patient management.

In an embodiment of the present invention, the management module 412 residing in the MPS platform 400 facilitates creating an information model by embedding appropriate healthcare data and medical device data such as, but not limited to, configuration files, patient data, software updates, firmware updates, applications, etc. within the device management protocol to facilitate performing the one or more tasks pertaining to the selected option. The information model is a formal representation of entity types that includes their properties, relationships, and the operations that can be performed on them. The entity types includes, but not limited to, medical devices, personal health gateways, and aggregators. The MPS platform transmits the information model to the one or more medical devices through the personal health gateways or aggregators. Furthermore, the healthcare data embedded within the device management protocol is extracted by the management client residing in the medical device. The extracted healthcare data and medical device data facilitates performing the required medical device management and/or remote health management task.

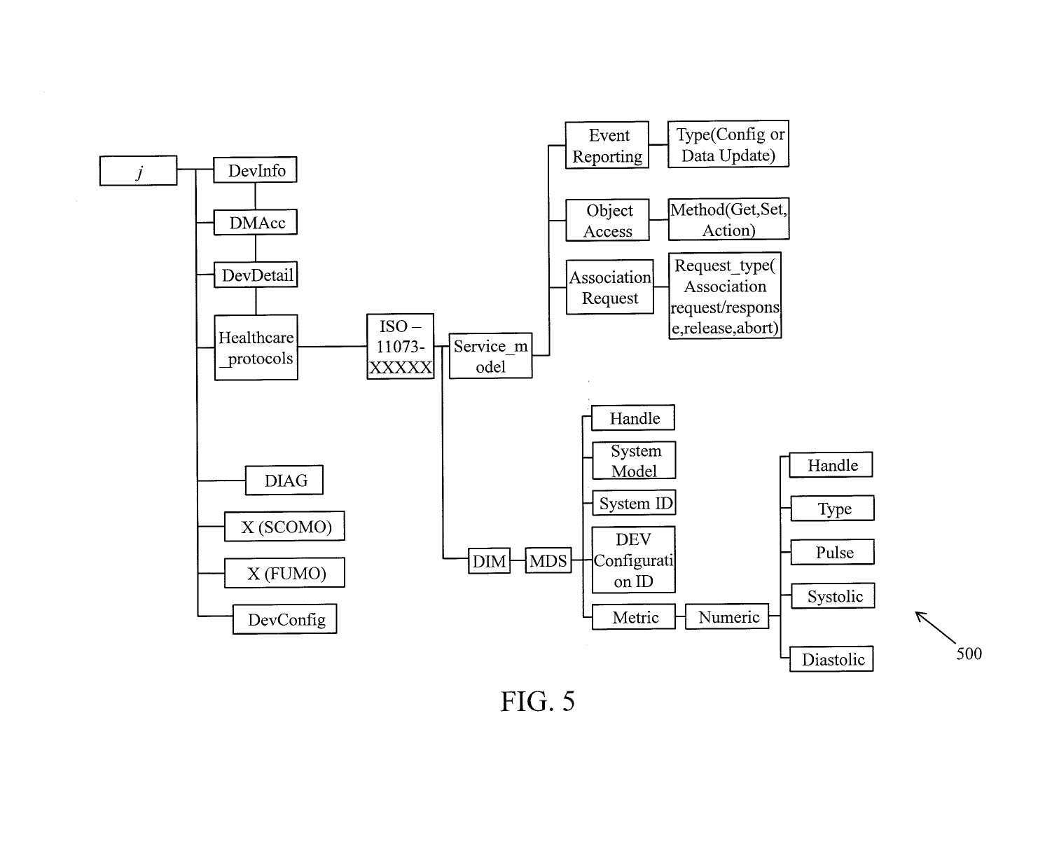

FIG. 5 is a management model illustrating an embedded 11073 Domain Information Model (DIM) node inside OMA DM tree 500 in accordance with an embodiment of the present invention. Medical device configuration data is organized in a hierarchical structure called the OMA DM tree which further branches into sub-trees, typically known as device management nodes. The nodes further extend to leaves which are usually single configuration parameters called management objects. Further, the OMA DM represents all available management objects of a particular device in a hierarchical tree structure where all nodes can be uniquely addressed with Universal Resource Identifiers (URIs). The OMA DM tree structure may be defined by one or more XML-formatted files, which describes the whole device management tree and/or separate management objects supported by the device. In an embodiment of the present invention, the OMA DM tree structure contains an embedded 11073 domain information model node and other OMA DM nodes containing metadata information including, but not limited to, patient id, provider id, doctor in charge etc.

In an exemplary embodiment of the present invention, the MPS platform may obtain current device configuration by inspecting the tree structure and values associated with the tree nodes of the OMA DM tree. In another exemplary embodiment of the present invention, the MPS platform may also change the configuration of the device by manipulating OMA DM tree structure and/or node values, using a small fixed set of commands. In various exemplary embodiments of the present invention, the structure of the OMA DM tree and available set of commands for its manipulation may depend on the medical device model.

In an exemplary embodiment of the present invention, the software of one or more medical devices may be updated using the standard OMA DM Software Component Management Object (SCOMO). In another exemplary embodiment of the present invention, the firmware of one or more medical devices may be updated using the standard OMA DM Firmware Update Management Object (FUMO).

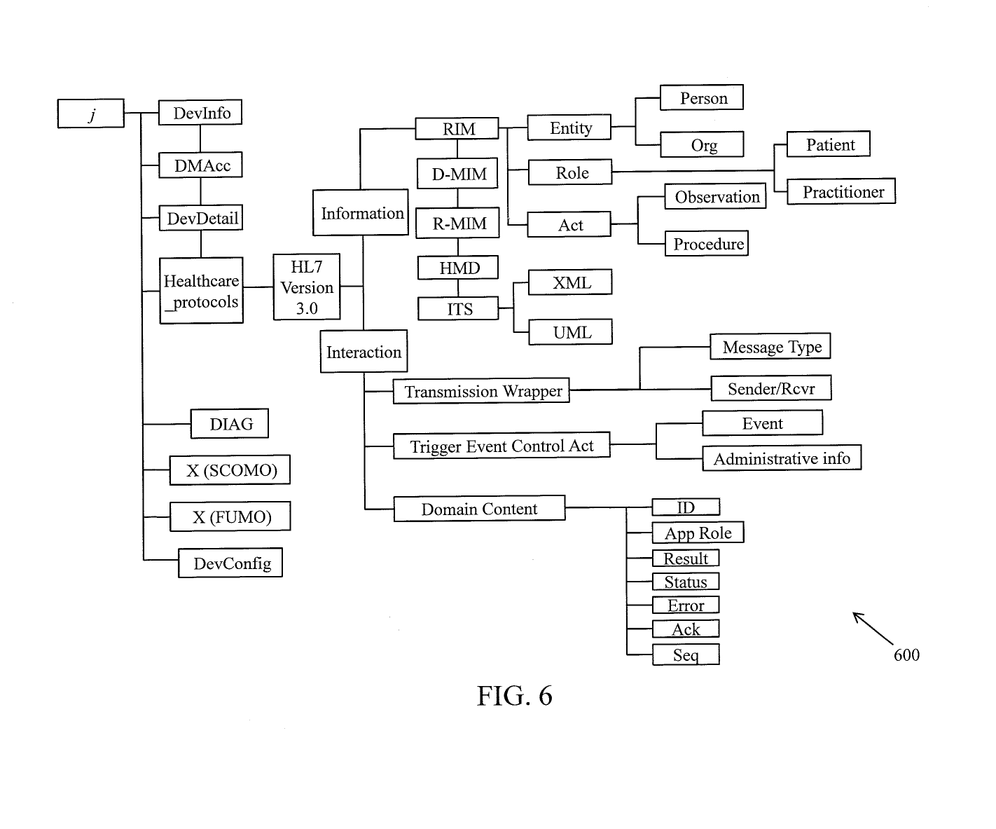

FIG. 6 is a management model illustrating an embedded HL7 Version 3.0 Reference Information Model (RIM) node inside OMA DM tree in accordance with an embodiment of the present invention. The RIM conforms to the object-oriented concepts of information modeling. The HL7 Development Framework i.e. RIM provides HL7 specification which is used for creating and exchanging healthcare information. Also, the HL7 Version 3.0 uses Extensible Markup Language (XML) to define health messages. In an embodiment of the present invention, health messages track any health related event and/or information in an XML document. Further, the HL7 message is defined as interactions between a sender and receiver for a particular device and patient management task. The sender and receiver include the one or more medical devices, the one or more personal health gateways, the one or more aggregators, and the MPS platform. The sender sends the information as healthcare entities, their status, their relationships etc. in an XML format. On receiving XML message at the receiver's side, an information model is created by interpreting and extracting the participating entities and their relationships from the XML message.

The HL7 message as embedded inside the OMA DM tree 600 comprises of three main sub trees including, but not limited to, transmission wrapper, trigger event control act, and domain content. An exemplary OMA DM XML code with HL7 plugged into its tree for a patient's device and his blood glucose report as seen on the receiver's side is illustrated below:

<?xml version=″1.0″ encoding=″UTF-8″?>
<response xmlns=”urn:omadmrelated” xmlns=″urn:h17-org:v3″>
<item>
<deviceInfoInfo>
<objectId>OBJ1</objectId>

```
  <uniqueDeviceId>DEV1</uniqueDeviceId>
  <manufacturer>MFTR1</manufacturer>
  <model>MODEL1</model>
  <dmV>VER1.0</dmV>
  <language>US_ENG</language>
```

</deviceInfoInfo>
<healthcareProtocols>
<!-- the h17 message representing the observation of the -->
<!-- glucose test event xml -->
<h17 version=”3.0”>
<!-- Transmission Wrapper -->
<!-- every message has a unique message interaction identifier(
<id root=″1.1.1.1.1.1.1″ extension=″INT_123″/>
<!-- time the event was created -->
<creationTime value=″200202190415-0700″/>
<versionCode code=″2010-11″/>
<!-- interaction id -->
<interactionId root=″2.2.2.2.2.2.2″ extension=″SAMPLE_IN111″/>
<processingCode code=″P″/>
<processingModeCode nullFlavor=″OTH″/>
<acceptAckCode code=″ER″/>
<!-- receiver details (device, location etc)-->
<receiver typeCode=″RCVR″>

<device classCode=″RCVRDEV″ determinerCode=″INSTANCE″>

<id extension=″BLK1 LAB″ root=″3.3.3.3.3.3.3″/>
<asLocatedEntity classCode=″LOCE″>

<location classCode=″PLC″ determinerCode=″INSTANCE″>

<id root=″4.4.4.4.4.4.4.4″ extension=″BLK1″/>

</location>

</asLocatedEntity>

</device>

</receiver>
<!-- sender details (device, location etc)-->
<sender typeCode=″SNDR″>

<device classCode=″SNDRDEV″ determinerCode=″INSTANCE″>

<id root=″5.5.5.5.5.5.5.5″ extension=″BLK2 LAB″/>
<asLocatedEntity classCode=″LOCE″>

<location classCode=″PLC″ determinerCode=″INSTANCE″>

<id root=″6.6.6.6.6.6.6″ extension=″BLK2″/>

</location>

</asLocatedEntity>

</device>

</sender>

<!-- Trigger Event Control Act -- >
<controlActProcess classCode=″CACT″ moodCode=″EVN″>
<code code=″INT_TE224200″ codeSystem=″7.7.7.7.7.7.7″/>
<subject typeCode=″SUBJ″ contextConductionInd=″false″>
<!-- domain content (event details like type of event, date/time, status, -
->
<!-- result, actors participating in the event, results etc) -->
<observationEvent>
<!-- id is the order number -->
<id root=″8.8.8.8.8.8.8.8″ extension=″778899″

assigningAuthorityName=″BLK1 LAB Filler Orders″/>

<code code=″1554-5″ codeSystemName=″LN″

codeSystem=″9.9.9.9.9.9.9.9″
displayName=″GLUCOSE\hat{ }POST 12H CFST:MCNC:PT:SER/PLAS:QN″/>

<statusCode code=″completed″/>

<!-- time the sample was taken -->
<effectiveTime value=″200202151230″/>
<!-- time of the actual lab test -->
<activity_time>

<dt:center value=″2002-02-15T03:10:00″/>

</activity_time>
<priorityCode code=″R″/>
<confidentialityCode code=″N″

codeSystem=″10.10.10.10.10.10″/>

<!-- test result -->
<value xsi:type=″PQ″ value=″191″ unit=″mg/dL″/>
<interpretationCode code=″H″/>
<!-- provides normal values for this test-->
<referenceRange>

<interpretationRange>

```
  <value xsi:type=″IVL_PQ″>
  <low value=″70″ unit=″mg/dL″/>
  <high value=″105″ unit=″mg/dL″/>
```

```
  </value>
  <interpretationCode code=″N″/>
```

</interpretationRange>

</referenceRange>
<!-- details of patient -->
<recordTarget>

```
  <patientClinical>
  <id root=″11.11.11.11.11.11″ extension=″444-22-5454″
```

assigningAuthorityName=″BLK1 Lab Patient IDs″/>

<statusCode code=″active″/>

<patientPerson>

<name use=″L″>

<given>Ruth</given>
<given>C</given>
<family>Barry</family>

```
  </name>
  <asOtherIDs>
```

<id extension=″AC76767676″ assigningAuthorityName=″SSN″

root=″12.12.12.12.12.12″/>

</asOtherIDs>

</patientPerson>

</patientClinical>

</recordTarget>

<!-- placed order -->
<inFulfillmentOf>

<placerOrder>
<id root=″13.13.13.13.13.13″ extension=″888888″

assigningAuthorityName=″BLK1 OE Placer orders″/>

</placerOrder>

</inFulfillmentOf>
</observationEvent>
</subject>
</controlActProcess>

</h17>
</healthcareProtocols>
</item>
</response>

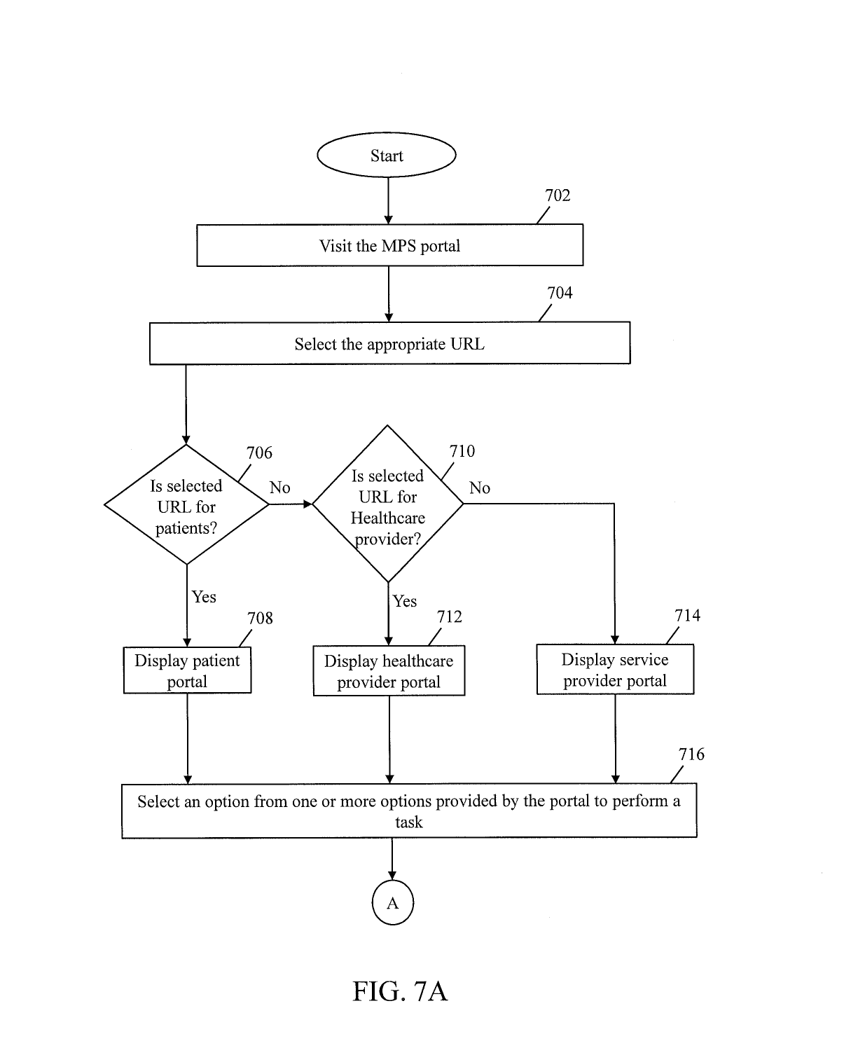

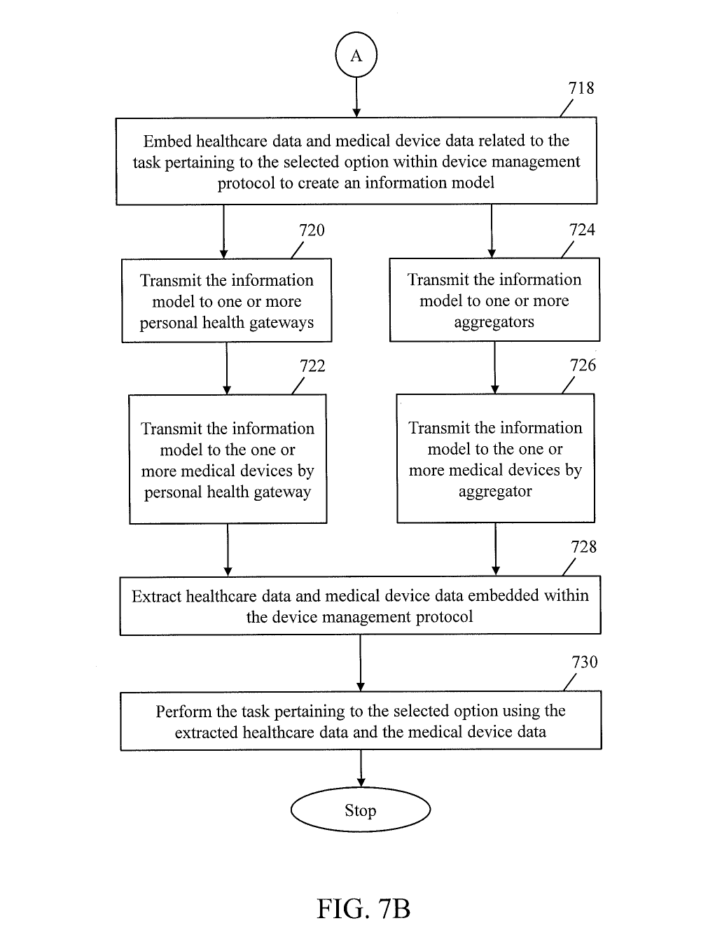

FIG. 7A and FIG. 7B is a flowchart illustrating a method for holistically managing medical devices and patients in accordance with an embodiment of the present invention.

At step 702, a user visits the MPS portal using an electronic communication device to access various options provided by the MPS platform to perform tasks such as, but not limited to, medical device management tasks, remote health management tasks, patient management tasks etc. In an embodiment of the present invention, the MPS portal may be a web portal providing various Universal Resource Locators (URLs) for different categories of users such as, but not limited to, healthcare providers, service providers, and patients. The user may select a particular URL to access the appropriate user portal using his electronic communication device. In another embodiment of the present invention, the user may directly enter the web address of the appropriate user portal such as, but not limited to, patient portal, healthcare provider portal, service provider portal, etc. In yet another embodiment of the present invention, the user may be prompted to enter authentication details to access the appropriate portal. The authentication details includes, but not limited to, user ID, login ID, password, string of characters, personal identification number (PIN), or any biometric identification. In various embodiments of the present invention, electronic communication device may include, but not limited to, a laptop, mobile, palmtop, notebook, desktop, personal health gateway, etc.

At step 704, a user selects an appropriate Universal Resource Locator (URL) from a list of URLs provided by the MPS portal to access a particular user portal of the MPS platform and perform one or more medical device management and remote health management tasks. In an embodiment of the present invention, the user may enter the appropriate web address to access the user portal such as service provider portal, healthcare provider portal or patient portal to perform one or more device management and/or remote health management tasks.

In an embodiment of the present invention, the medical device management includes tasks such as, but not limited to, updating medical device software, updating medical device firmware, installing new device applications, monitoring health of battery, detecting bugs and faults, resetting device counters, configuring medical devices, allocating medical devices, de-allocating medical devices, requesting patient data, device reset/lock/shutdown, device diagnostics, device backup, device auditing/logging, device fault management or any other task related to device management. In another embodiment of the present invention, the remote health management includes tasks such as, but not limited to, dynamic workflow management of patient therapy/treatment, altering flow of patient data collection, adding questions to ask patient, answering questions posted by healthcare practitioner, accessing patient profiles, or any other task related to remote health management or patient management.

At step 706, a check is performed to ensure whether the selected URL is for patients. If it is ascertained that the selected URL is for patients, then at step 708, a patient portal is displayed. If it is ascertained that the selected URL is not for patients then at step 710, another check is performed to ensure whether the selected URL is for healthcare provider.

At step 708, the MPS platform displays the patient portal to provide one or more appropriate options to the patient to facilitate performing one or more related tasks. In various embodiments of the present invention, the patient portal provides options to facilitate performing various device and remote health management tasks such as, but not limited to, accessing personal profile, vitals history, health history, answering question posted by healthcare practitioner, managing medical devices, device lock/reset/shutdown, etc. In an exemplary embodiment of the present invention, the patient portal may be personalized for each patient. Further, the patient may communicate with healthcare personnel through the patient portal using his electronic communication device. Furthermore, the patient may answer the questions posted to him by the doctor through the patient portal. In another exemplary embodiment of the present invention, the patient may access the patient portal using his personal health gateway.

At step 710, a check is performed to ensure whether the selected URL is for healthcare providers. If it is ascertained that the selected URL is for healthcare providers, then at step 712, a healthcare provider portal is displayed. If it is ascertained that the selected URL is not for healthcare provider then at step 714, a service provider portal is displayed.

At step 712, the MPS platform displays the healthcare provider portal to provide one or more appropriate options to the healthcare provider to perform one or more tasks related to medical device management and/or remote health management. Healthcare provider includes users such as, but not limited to, healthcare personnel, healthcare practitioner, doctor, caregiver, nurse, healthcare personnel, etc. In various embodiments of the present invention, the healthcare provider portal provides one or more options such as, but not limited to, modifying workflow, modifying disease profiles, accessing patient data, allocating/de-allocating medical devices and/or personal health gateways and/or aggregators to patients, configuring medical devices, adding questions to ask patients, altering flow of data collection, etc. to facilitate the healthcare provider to perform tasks related to medical device management and remote health management. In an exemplary embodiment of the present invention, a doctor may access patient's profile and view patient specific vitals through the healthcare provider portal on his laptop. In another exemplary embodiment of the present invention, the healthcare provider may assign one or more medical devices, personal health gateways and/or aggregators to patients through healthcare provider portal. In yet another exemplary embodiment of the present invention, the healthcare provider may view information pertaining to medical devices, personal health gateways, and aggregators rented by a service provider.

In an embodiment of the present invention, the MPS platform facilitates dynamic workflow management of patient therapy/treatment. The healthcare provider may log in to the healthcare provider portal to perform tasks such as, but not limited to, altering flow of data collection for a patient, adding questions to ask the patient by using a drag-drop user interface, process flow diagrams, configuration files, etc.

At step 714, the MPS platform displays the service provider portal to provide one or more appropriate options to the service provider to perform one or more tasks related to medical device management and/or remote health management. The service provider portal provides various options to the service provider to perform tasks such as, but not limited to, allocating/de-allocating medical devices, personal health gateways and aggregators to patients or healthcare providers, updating software or firmware of medical device, installing software applications on one or more medical devices, resetting counters of medical device, detecting bugs and faults in medical devices, monitoring health of battery, device reset/lock/shutdown, device diagnostics, device backup, device auditing/logging, device fault management or any other task related to medical device management and/or remote health management. In various embodiments of the present invention, the service provider includes users such as, but not limited to, device manufacturers, service engineers, OEMs, device vendors, etc. In an exemplary embodiment of the present invention, the service provider may allocate medical devices to a healthcare provider through the service provider portal. In another exemplary embodiment of the present invention, the service provider may view data related to medical devices, personal health gateways and aggregators rented to one or more healthcare providers. In yet another exemplary embodiment of the present invention, the service provider may reset the medical device and upload new configuration files when the medical device is transferred to a different healthcare provider through the service provider portal.

In various embodiments of the present invention, there may be separate portals for different users such as, but not limited to, healthcare practitioner portal, doctor's portal, caregiver portal, nurse's portal, healthcare personnel's portal, device manufacturer's portal, service provider portal, healthcare provider portal, service engineer portal, OEM portal, administration portal, IT management portal, etc. to provide appropriate options to a particular category of users. In an embodiment of the present invention, the user may access the appropriate portal using his electronic communication device by selecting a particular URL or entering a particular web address.

At step 716, the user selects an option from the one or more options provided by the portal to perform a required medical device management and/or remote health management task. In an embodiment of the present invention, the healthcare provider may select an option to alter the flow of data collection for a patient. In another embodiment of the present invention, the patient may access the patient portal to answer a question posted by the healthcare practitioner. In yet another embodiment of the present invention, the service provider may select an option to remotely upgrade the software of a medical device.

At step 718, the MPS platform facilitates embedding healthcare data and medical device data related to the task pertaining to the selected option within a device management protocol to create an information model. The medical device data includes data such as, but not limited to, device ID, configuration files, device details, etc. The healthcare data includes data such as, but not limited to, patient data, patient ID, provider ID, doctor in-charge, disease profile, flow of data collection, etc.

At step 720, the MPS platform transmits the information model to one or more personal health gateways using the device management protocol. At step 722, the personal health gateway facilitates transmitting the information model to the appropriate one or more medical devices using the device management protocol.

At step 724, the MPS platform transmits the information model to one or more aggregators using the device management protocol. At step 726, the aggregator facilitates transmitting the information model to the appropriate one or more medical devices using the device management protocol.

At step 728, the medical device extracts the healthcare data and the medical device data embedded within the device management protocol. In an embodiment of the present invention, the healthcare data and the medical device data is extracted by the management client residing in the medical device.

At step 730, the medical device performs the task pertaining to the selected option using the extracted healthcare data and the medical device data. In an embodiment of the present invention, the management client residing in the medical device may facilitate installing new applications on the medical device. In another embodiment of the present invention, the medical device software or firmware is upgraded. In yet another embodiment of the present invention, the flow of data collection is altered as per the patient therapy/treatment.

In an alternate embodiment of the present invention, the personal health gateway and/or aggregator may act as a proxy management client on behalf of medical devices such as, but not limited to, implantable devices wherein a management client cannot be implemented. Further, the management client residing in the personal health gateway and/or aggregator facilitates extracting healthcare data and medical device data embedded within the device management protocol. Furthermore, the management client residing in the personal health gateway and/or aggregator facilitates performing the required task using the extracted healthcare data and medical device data.

In yet another alternate embodiment of the present invention, the MPS platform may directly communicate with the one or more medical devices. The user selects an option through the user interface provided by the MPS platform to perform one or more tasks related to device management and/or remote health management. The management module residing in the MPS platform 400 facilitates creating an information model by embedding appropriate healthcare data and medical device data such as, but not limited to, configuration files, patient data, software updates, firmware updates, applications, etc. within the device management protocol to facilitate performing the one or more tasks pertaining to the selected option. The information model is a formal representation of entity types such as, but not limited to, medical devices that include their properties, relationships, and the operations that can be performed on them. The MPS platform transmits the information model to the one or more medical devices using the device management protocol. Furthermore, the healthcare data and medical device data embedded within the device management protocol is extracted by the management client residing in the medical device. The extracted healthcare data and medical device data facilitates performing the required medical device management and/or remote health management task.

The present invention may be implemented in numerous ways including as an apparatus, method, or a computer program product such as a computer readable storage medium or a computer network wherein programming instructions are communicated from a remote location.

Various embodiments of the present invention, may be implemented via one or more computer systems. The computer system includes at least one processing unit and memory. The processing unit executes program instructions and may be a real or a virtual processor. The computer system is not intended to suggest any limitation as to scope of use or functionality of described embodiments. Typical examples of a computer system include a general-purpose computer, a programmed microprocessor, a micro-controller, a peripheral integrated circuit element, and other devices or arrangements of devices that are capable of implementing the steps that constitute the method of the present invention. In an embodiment of the present invention, the memory may store software for implementing various embodiments of the present invention.

The present invention may suitably be embodied as a computer program product for use with a computer system. The method described herein is typically implemented as a computer program product, comprising a set of program instructions which is executed by a computer system or similar device. The set of program instructions may be a series of computer readable codes stored on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

1. A system for remote management of patients and medical devices, the system comprising:
one or more medical devices configured to measure one or more patient's health parameters;
a personal health gateway configured to receive the one or more measured patient's health parameters, wherein the personal health gateway further comprises a management module;
a public network configured to connect the one or more personal health gateways to a Managed Patient Services (MPS) platform;
the MPS platform configured to facilitate remote management of the one or more medical devices and patients, wherein the MPS platform further comprises a management module; and
a hospital system configured to facilitate one or more functionality of a healthcare facility;
wherein the management module facilitates medical device management and remote health management by embedding a healthcare protocol with a device management protocol.

2. The system of claim 1, wherein the medical device comprises:
a management client configured to facilitate medical device management and remote health management by embedding a healthcare protocol with a device management protocol.

3. The system of claim 2, wherein the management client further comprises:
a tree management module configured to manage one or more management trees, and further configured to facilitate medical device management and remote health management.

4. The system of claim 1, further comprising a home network configured to connect the one or more medical devices with the personal health gateway, wherein the one or more medical devices and the personal health gateway are residing at patient premise.

5. The system of claim 1, wherein the personal health gateway comprises:
a disease models repository configured to store data pertaining to one or more disease models.

6. The system of claim 1, wherein the MPS platform comprises:
a healthcare provider portal configured to provide one or more options to one or more healthcare providers to perform one or more tasks pertaining to medical device management and remote health management;
a service provider portal configured to provide one or more options to one or more service providers to perform one or more tasks pertaining to medical device management and remote health management; and
a patient portal configured to provide one or more options to one or more patients to perform one or more tasks pertaining to medical device management and remote health management.

7. The system of claim 1, wherein the MPS platform comprises:
a disease models repository, configured to store data pertaining to disease models.

8. A system for remote management of patients and medical devices, the system comprising:
one or more medical devices configured to measure one or more patient's health parameters;
an aggregator configured to aggregate the one or more measured patient's health parameters, wherein the aggregator further comprises a management module;
a public network configured to connect the one or more aggregators to a Managed Patient Services (MPS) platform;
the MPS platform configured to facilitate remote management of the one or more medical devices and patients, wherein the MPS platform further comprises a management module; and
a hospital system configured to facilitate one or more functionality of a healthcare facility;
wherein the management module facilitates medical device management and remote health management by embedding a healthcare protocol with a device management protocol.

9. The system of claim 8, wherein the medical device comprises:
a management client configured to facilitate medical device management and remote health management by embedding a healthcare protocol with a device management protocol.

10. The system of claim 9, wherein the management client further comprises:
a tree management module configured to manage one or more management trees, and further configured to facilitate medical device management and remote health management.

11. The system of claim 8, further comprising a home network configured to connect the one or more medical devices with the aggregator, wherein the one or more medical devices and the aggregator are residing at patient premise.

12. The system of claim 8, wherein the MPS platform comprises:
a healthcare provider portal configured to provide one or more options to one or more healthcare providers to perform one or more tasks pertaining to medical device management and remote health management;
a service provider portal configured to provide one or more options to one or more service providers to perform one or more tasks pertaining to medical device management and remote health management; and
a patient portal configured to provide one or more options to one or more patients to perform one or more tasks pertaining to medical device management and remote health management.

13. The system of claim 8, wherein the MPS platform comprises:
a disease models repository, configured to store data pertaining to disease models.

14. A system for remote management of patients and medical devices, the system comprising:
one or more medical devices configured to measure one or more patient's health parameters;
an aggregator configured to aggregate the one or more measured patient's health parameters, wherein the aggregator further comprises a management module;
a hospital network configured to connect the one or more aggregators to a Managed Patient Services (MPS) platform;
the MPS platform configured to facilitate remote management of the one or more medical devices and patients, wherein the MPS platform further comprises a management module; and
a hospital system configured to facilitate one or more functionality of a healthcare facility;
wherein the management module facilitates medical device management and remote health management by embedding a healthcare protocol with a device management protocol.

15. The system of claim 14, wherein the medical device comprises:
a management client configured to facilitate medical device management and remote health management by embedding a healthcare protocol with a device management protocol.

16. The system of claim 15, wherein the management client further comprises:
a tree management module configured to manage one or more management trees, and further configured to facilitate medical device management and remote health management.

17. The system of claim 14, further comprising a device network configured to connect the one or more medical devices with the aggregator, wherein the one or more medical devices and aggregator are residing at the healthcare facility.

18. The system of claim 14, wherein the MPS platform comprises:
a healthcare provider portal configured to provide one or more options to one or more healthcare providers to perform one or more tasks pertaining to medical device management and remote health management;
a service provider portal configured to provide one or more options to one or more service providers to perform one or more tasks pertaining to medical device management and remote health management; and
a patient portal configured to provide one or more options to one or more patients to perform one or more tasks pertaining to medical device management and remote health management.

19. The system of claim 14, wherein the MPS platform comprises:
a disease models repository, configured to store data pertaining to disease models.

20. A system for remote management of patients and medical devices, the system comprising:
one or more medical devices configured to measure one or more patient's health parameters;
a Managed Patient Services (MPS) platform configured to facilitate remote management of the one or more medical devices and patients, wherein the MPS platform further comprises a management module; and
a hospital system configured to facilitate one or more functionality of a healthcare facility;
wherein the management module facilitates medical device management and remote health management by embedding a healthcare protocol with a device management protocol.

21. The system of claim 20, wherein the medical device comprises:
a management client configured to facilitate medical device management and remote health management by embedding a healthcare protocol with a device management protocol.

22. The system of claim 21, wherein the management client further comprises:
a tree management module configured to manage one or more management trees, and further configured to facilitate medical device management and remote health management.

23. The system of claim 20, further comprising:
a public network configured to connect the one or more medical devices to the MPS platform, wherein the one or more medical devices are residing at patient premise.

24. The system of claim 20, further comprising:
a hospital network configured to connect the one or more medical devices to the MPS platform, wherein the one or more medical devices are residing at the healthcare facility.

25. The system of claim 20, wherein the MPS platform comprises:
a healthcare provider portal configured to provide one or more options to one or more healthcare providers to perform one or more tasks pertaining to medical device management and remote health management;
a service provider portal configured to provide one or more options to one or more service providers to perform one or more tasks pertaining to medical device management and remote health management; and
a patient portal configured to provide one or more options to one or more patients to perform one or more tasks pertaining to medical device management and remote health management.

26. The system of claim 20, wherein the MPS platform comprises:
a disease models repository, configured to store data pertaining to disease models.

27. A method for remote management of patients and medical devices, the method comprising the steps of:
(i) measuring one or more patient's health parameters by one or more medical devices;
(ii) transmitting the measured one or more patient's health parameters and medical device data to a personal health gateway;
(iii) converting the measured one or more patient's health parameters into a predetermined healthcare protocol format to obtain healthcare data;
(iv) embedding the medical device data and the healthcare data within a device management protocol to create an information model;
(v) transmitting the information model to a Managed Patient Services (MPS) platform using the device management protocol; and
(vi) extracting the healthcare data and the medical device data embedded within the device management protocol.

28. A method for remote management of patients and medical devices, the method comprising the steps of:
(i) measuring one or more patient's health parameters by one or more medical devices;
(ii) transmitting the measured one or more patient's health parameters and medical device data to an aggregator;
(iii) converting the measured one or more patient's health parameters into a predetermined healthcare protocol format to obtain healthcare data;
(iv) embedding the medical device data and the healthcare data within a device management protocol to create an information model;
(v) transmitting the information model to a Managed Patient Services (MPS) platform using the device management protocol; and
(vi) extracting the healthcare data and the medical device data embedded within the device management protocol.

29. A method for remote management of patients and medical devices, the method comprising the steps of:
(i) selecting an option from one or more options provided by a user interface;
(ii) triggering an MPS platform to facilitate performing a task pertaining to the selected option;
(iii) embedding healthcare data and medical device data related to the task pertaining to the selected option within a device management protocol to create an information model;
(iv) transmitting the information model to a personal health gateway using the device management protocol;
(v) receiving the information model by the personal health gateway;
(vi) transmitting the information model to one or more medical devices using the device management protocol;
(vii) extracting the healthcare data and the medical device data embedded within the device management protocol; and
(viii) performing the task pertaining to the selected option using the extracted healthcare data and the medical device data.

30. The method of claim 29, wherein the task pertaining to the selected option at least comprises: altering flow of data collection, adding questions to ask patient, managing workflow of patient therapy or treatment dynamically, updating medical device software, updating medical device firmware, installing new applications, monitoring health of battery, detecting bugs and faults, resetting device counters, configuring medical devices, allocating medical devices, de-allocating medical devices, requesting patient data, resetting medical device, locking medical device, facilitating medical device shutdown, facilitating medical device diagnostics, maintaining device backup, auditing/logging medical device, managing medical device faults or any other task related to medical device management or remote health management.

31. The method of claim 29, wherein the healthcare data at least comprises: patient data, configuration files, software updates, firmware updates, or any other related healthcare data.

32. The method of claim 29, wherein the medical device data at least comprises: device ID, device information, device details, or any other related medical device data.

33. A method for remote management of patients and medical devices, the method comprising the steps of:
(i) selecting an option from one or more options provided by a user interface;
(ii) triggering an MPS platform to facilitate performing a task pertaining to the selected option;
(iii) embedding healthcare data and medical device data related to the task pertaining to the selected option within a device management protocol to create an information model;
(iv) transmitting the information model to an aggregator using the device management protocol;
(v) receiving the information model by the aggregator;
(vi) transmitting the information model to one or more medical devices using the device management protocol;
(vii) extracting the healthcare data and the medical device data embedded within the device management protocol; and
(viii) performing the task pertaining to the selected option using the extracted healthcare data and the medical device data.

34. The method of claim 33, wherein the task pertaining to the selected option may at least comprise: altering flow of data collection, adding questions to ask patient, managing workflow of patient therapy or treatment dynamically, updating medical device software, updating medical device firmware, installing new applications, monitoring health of battery, detecting bugs and faults, resetting device counters, configuring medical devices, allocating medical devices, de-allocating medical devices, requesting patient data, resetting medical device, locking medical device, facilitating medical device shutdown, facilitating medical device diagnostics, maintaining device backup, auditing/logging medical device, managing medical device faults or any other task related to medical device management or remote health management.

35. The method of claim 33, wherein the healthcare data at least comprises: patient data, configuration files, software updates, firmware updates, or any other related healthcare data.

36. The method of claim 33, wherein the medical device data at least comprises: device ID, device information, device details, or any other related medical device data.

37. A method for remote management of patients and medical devices, the method comprising the steps of:
(i) measuring one or more patient's health parameters by one or more medical devices;
(ii) converting the measured one or more patient's health parameters into a predetermined healthcare protocol format to obtain healthcare data;
(iii) embedding the medical device data and the healthcare data within a device management protocol to create an information model;
(iv) transmitting the information model to a Managed Patient Services (MPS) platform using the device management protocol; and
(v) extracting the healthcare data and the medical device data embedded within the device management protocol.

38. A method for remote management of patients and medical devices, the method comprising the steps of:
(i) selecting an option from one or more options provided by a user interface;
(ii) triggering an MPS platform to facilitate performing a task pertaining to the selected option;
(iii) embedding healthcare data and medical device data related to the task pertaining to the selected option within a device management protocol to create an information model;
(iv) transmitting the information model to one or more medical devices using the device management protocol;
(v) extracting the healthcare data and the medical device data embedded within the device management protocol; and
(vi) performing the task pertaining to the selected option using the extracted healthcare data and the medical device data.

39. The method of claim 38, wherein the task pertaining to the selected option may at least comprise: altering flow of data collection, adding questions to ask patient, managing workflow of patient therapy or treatment dynamically, updating medical device software, updating medical device firmware, installing new applications, monitoring health of battery, detecting bugs and faults, resetting device counters, configuring medical devices, allocating medical devices, de-allocating medical devices, requesting patient data, resetting medical device, locking medical device, facilitating medical device shutdown, facilitating medical device diagnostics, maintaining device backup, auditing/logging medical device, managing medical device faults or any other task related to medical device management or remote health management.

40. The method of claim 38, wherein the management data at least comprises: patient data, configuration files, software updates, firmware updates, or any other related healthcare data.

41. The method of claim 38, wherein the medical device data at least comprises: device ID, device information, device details, or any other related medical device data.
